(19) United States
(12) Patent Application Publication
(10) Pub. No.: US 2021/0246341 A1
(43) Pub. Date: Aug. 12, 2021

(54) PHOTOCURABLE ADHESIVE COMPOSITION FOR OPTICAL FILM, PHOTOCURABLE ADHESIVE LAYER FOR OPTICAL FILM, OPTICAL MEMBER, AND DISPLAY APPARATUS

(71) Applicant: SAMSUNG SDI CO., LTD., Yongin-si (KR)

(72) Inventors: Inui KUNIHIRO, Yokohama-shi (JP); Suda KAORU, Yokohama-shi (JP)

(21) Appl. No.: 17/171,806

(22) Filed: Feb. 9, 2021

(30) Foreign Application Priority Data
Feb. 10, 2020 (JP) 2020-020666
Feb. 10, 2020 (JP) 2020-020671
Nov. 6, 2020 (KR) 10-2020-0148135
Nov. 6, 2020 (KR) 10-2020-0148136

(51) Int. Cl. C09J 133/08; B32B 7/12; B32B 17/10; B32B 27/08; B32B 27/36; B32B 27/30

(52) U.S. Cl. CPC C09J 133/08; B32B 7/12; B32B 17/10; B32B 2457/206; B32B 27/365; B32B 27/308; B32B 2457/202; B32B 27/08

(57) ABSTRACT

A photocurable adhesive composition is provided and can form an adhesive layer having good step-filling properties and durability under harsh conditions (high temperature, high humidity, thermal shock), exhibiting good properties in terms of haze, processability and adhesive strength after moist heat durability testing, and allowing reduction in permittivity. The photocurable adhesive composition includes a main component and a chain transfer agent. The main component includes a (meth)acrylic acid ester copolymer (a) having a particular structure, and the chain transfer agent is present in an amount of about 0.01 parts by weight to about 5 parts by weight relative to 100 parts by weight of the main component.

### CROSS-REFERENCE TO RELATED APPLICATIONS

This application claims priority to and the benefit of Japanese Patent Application No. 2020-020666, filed on Feb. 10, 2020, Japanese Patent Application No. 2020-020671, filed on Feb. 10, 2020, Korean Patent Application No. 10-2020-0148135, filed on Nov. 6, 2020, and Korean Patent Application No. 10-2020-0148136, filed on Nov. 6, 2020, the entire disclosures of all of which are incorporated herein by reference.

### BACKGROUND

### 1. Field

Aspects of embodiments of the present invention relate to a photocurable adhesive composition for optical films, a photocurable adhesive layer for optical films, an optical member, and a display apparatus.

### 2. Description of the Related Art

Currently, liquid crystal display panels (LCDs) and organic EL display panels are mainly used as display panels. In general, a laminate having multiple films stacked therein may be bonded to a surface of a display panel. For example, in an LCD, optical films, such as a polarizing plate, a retardation plate, a viewing angle enlargement film, and a brightness enhancing film, are stacked on a surface of a liquid crystal panel. In addition, each layer constituting the display panel may be bonded to another layer via an adhesive layer formed of any of various adhesives.

In recent years, for a mobile display represented by a smartphone, a release process, such as a process of forming a curved surface, recesses, or holes, is generally performed on an edge of the display.

Such a release process is performed on an optical film laminate including optical films stacked via an adhesive layer or a bonding layer. To this end, such an optical film requires processing properties beyond typical processability required for an existing optical film or optical film laminate. In particular, the optical film requires good workability to suppress thermal damage while preventing the edge of the adhesive layer from being peeled off or lifted due to friction upon spindle processing or stress upon sampling.

Further, in addition to processability, the optical film is required to prevent peeling or lifting even when stored for a long time under various conditions for testing optical properties or durability required for adhesives for optical films.

In recent years, with the development of thinner and lighter optical devices, such as mobile phones and mobile terminals, various tasks have arisen. In an optical device having a touch sensor function, particularly a popular capacitive type touch function, a capacitor is formed between two electrodes facing each other with an insulating film interposed therebetween to determine a location based on variation in capacitance of the capacitor, which occurs when a conductor, such as a finger or the like, approaches the capacitor from one side of a protective panel. However, for slimness of members for the optical device, a gap between the electrode and a surface of the protective panel becomes narrow, causing an increase in capacitance variation of the capacitor upon touch, whereby noise is likely to occur in detection signals.

Further, as the gap between the members is also narrowed in addition to weight reduction and slimness of the members, an additional reduction in thickness is required for a filling member used for integration of the members, such as an adhesive sheet or the like. Accordingly, an adhesive sheet used for filling the gap between the electrode and the protective panel is required to have low permittivity in order to absorb change in touch detection sensitivity due to slimness of the members or the adhesive sheet itself.

With reduction in weight or costs of the electrodes, a glass electrode substrate may be replaced by a resin film. For an electrode having a pattern of a conductive thin film on a surface thereof, it is necessary to stack two film electrodes or a glass electrode and a film electrode via an adhesive sheet, in which an adhesive layer is also required to have low permittivity.

Further, in order to impart cosmetic properties to a cover glass or a cover plastic film, black or white printing is performed on a side surface on which an optical adhesive layer is formed. Since a printed portion requires concealability, a printing ink layer having a certain thickness or more is formed thereon. Upon multistage printing of the cover glass or the cover plastic film and the optical adhesive layer, it is necessary to attach the optical adhesive layer to a stepped portion of the printing ink layer without a gap therebetween. Accordingly, the optical adhesive layer is required to have step-filling properties by which the adhesive layer fills a gap due to the stepped portion of the printing ink layer.

Examples of an adhesive (or a bonding agent) for optical films, an adhesive layer for optical films and a stacked structure are disclosed in JP Patent Unexamined Publication No. 2017-125195, JP Patent Publication No. 2015-524011, and the like.

### SUMMARY

According to an aspect of the present invention, a photocurable adhesive composition for optical films is provided, which can form an adhesive layer having good step-filling properties.

According to another aspect of the present invention, a photocurable adhesive composition is provided that can form an adhesive layer having durability under harsh conditions (high temperature, high humidity, thermal shock), exhibiting good property in terms of haze after moist heat durability testing, good properties in terms of processability and adhesive strength, and allowing reduction in permittivity.

According to one or more embodiments of the present invention, a photocurable adhesive composition for optical films includes a main component and a chain transfer agent, wherein the main component includes (a) a (meth)acrylic acid ester copolymer, the (meth)acrylic acid ester copolymer including about 15 wt % to about 55 wt % of a constituent unit derived from a component (a1): a linear or branched C₁ to C₁₄ alkyl group-containing (meth)acrylic acid ester monomer; about 10 wt % to about 55 wt % of a constituent unit derived from a component (a2): a cyclic C₃ to C₁₄ alkyl group-containing (meth)acrylic acid ester monomer; about 5 wt % to about 35 wt % of a constituent unit derived from a component (a3): a hydroxyl group-containing (meth)acrylic acid ester monomer; and about 5 wt % to about 35 wt % of a constituent unit derived from a component (a4): an amide group-containing monomer, wherein a sum of the constituent units derived from the components (a1) to (a4) is 100 wt % and the constituent unit derived from the component (a1) is present in an amount of about 20 wt % to about 60 wt % based on a total amount of the constituent units derived from the components (a1) and (a2), and wherein the chain transfer agent is present in an amount of about 0.01 parts by weight to about 5 parts by weight relative to 100 parts by weight of the main component.

According to one or more embodiments of the present invention, a photocurable adhesive composition for optical films includes a syrup obtained through partial polymerization of a (meth)acrylic acid ester monomer composition, a UV absorbent, and a chain transfer agent, wherein the UV absorbent is present in an amount of about 0.010 parts by weight to about 5 parts by weight and the chain transfer agent is present in an amount of about 0.010 parts by weight to about 5 parts by weight, relative to 100 parts by weight of the syrup.

According to an aspect of the present invention, an adhesive composition capable of forming an adhesive layer having good step-filling properties is provided.

According to another aspect of the present invention, an adhesive composition that can form an adhesive layer having durability under harsh conditions (high temperature, high humidity, thermal shock), exhibiting good property in terms of haze after moist heat durability testing, good properties in terms of processability and adhesive strength, and allowing reduction in permittivity is provided.

### BRIEF DESCRIPTION OF THE DRAWINGS

FIG. 1 is a cross-sectional view of a thin polarizing plate.

FIG. 2 is a perspective view of a sample for creep testing.

### DETAILED DESCRIPTION

Herein, some example embodiments of the present invention will be described in further detail with reference to the accompanying drawings. However, it should be understood that the present invention is not limited to the following embodiments and is defined by the claims. Herein, unless stated otherwise, manipulation and measurement of physical properties are performed under conditions of room temperature (20° C. to 25° C.)/40% relative humidity (RH) to 50% RH. In addition, “(meth)acryl” commonly refers to acryl and methacryl. Further, “(co)polymer” commonly refers to a homopolymer formed through polymerization of a single monomer and a copolymer formed through polymerization of multiple types of monomers.

<Photocurable Adhesive Composition for Optical Films>

A photocurable adhesive composition for optical films (herein, referred to as “adhesive composition”) in accordance with an aspect of the present invention includes a main component and a chain transfer agent, wherein the main component includes (a) a (meth)acrylic acid ester copolymer, the (meth)acrylic acid ester copolymer (a) including: about 15 wt % to about 55 wt % of a constituent unit derived from a component (a1): a linear or branched C₁ to C₁₄ alkyl group-containing (meth)acrylic acid ester monomer; about 10 wt % to about 55 wt % of a constituent unit derived from a component (a2): a cyclic C₃ to C₁₄ alkyl group-containing (meth)acrylic acid ester monomer; about 5 wt % to about 35 wt % of a constituent unit derived from a component (a3): a hydroxyl group-containing (meth)acrylic acid ester monomer; and about 5 wt % to about 35 wt % of a constituent unit derived from a component (a4): an amide group-containing monomer, wherein a sum of the constituent units derived from the components (a1) to (a4) is 100 wt % and the constituent unit derived from the component (a1) is present in an amount of about 20 wt % to about 60 wt % based on a total amount of the constituent units derived from the components (a1) and (a2), and wherein the chain transfer agent is present in an amount of about 0.01 parts by weight to about 5 parts by weight, relative to 100 parts by weight of the main component.

With an adhesive composition according to the present invention, an adhesive layer may be obtained having good step-filling properties and durability under harsh conditions (high temperature, high humidity, thermal shock), exhibits good property in terms of haze after moist heat durability testing, good properties in terms of processability and adhesive strength, and allows reduction in permittivity.

Herein, the “an amount of a constituent unit derived from a component” in the (meth)acrylic acid ester copolymer (a) may refer to an amount of the component present in a monomer mixture for the (meth)acrylic acid ester copolymer (a).

### Main Component

The adhesive composition according to the present invention includes the main component, which essentially includes (a) a (meth)acrylic acid ester copolymer (herein, also referred to as “copolymer (a)”). Herein, the “main component” refers to a component present in a largest amount in the adhesive composition.

### (Meth)acrylic Acid Ester Copolymer (a)

The copolymer (a) includes constituent units derived from components (a1) to (a4) as follows: about 15 wt % to about 55 wt % of a constituent unit derived from a component (a1): a (meth)acrylic acid ester monomer having a linear or branched C₁ to C₁₄ alkyl group; about 10 wt % to about 55 wt % of a constituent unit derived from a component (a2): a (meth)acrylic acid ester monomer having a cyclic C₃ to C₁₄ alkyl group; about 5 wt % to about 35 wt % of a constituent unit derived from a component (a3): a hydroxyl group-containing (meth)acrylic acid ester monomer; and about 5 wt % to about 35 wt % of a constituent unit derived from a component (a4): an amide group-containing monomer.

Here, a sum of the constituent units derived from the components (a1) to (a4) is 100 wt % and the constituent unit derived from the component (a1) is present in an amount of about 20 wt % to about 60 wt % based on a total amount of the constituent units derived from the components (a1) and (a2).

The components (a1) to (a4) are monomers each having a single (meth)acryloyl group per molecule. A monomer having two or more (meth)acryloyl groups in the molecule is classified as a crosslinking agent and is different from the components (a1) to (a4) and also from the component (a5), which will be described.

Herein, the components (a1) to (a4) will be described in further detail.

(a1): Linear or Branched C₁ to C₁₄ Alkyl Group-Containing (Meth)acrylic Acid Ester Monomer.

The copolymer (a) includes the constituent unit derived from the component (a1): the linear or branched C₁ to C₁₄ alkyl group-containing (meth)acrylic acid ester monomer (hereinafter referred to as “component (a1)”). In an adhesive layer and a cured product thereof, the constituent unit derived from the component (a1) acts as a basic main backbone of a polymer. The component (a1) may be used alone or in combination thereof. The component (a1) may be prepared by a typical method known in the art or may be obtained from commercially available products.

The component (a1) is represented by the following Formula (1):

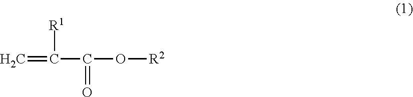

where R¹ is a hydrogen atom or a methyl group and R² is a C₁ to C₁₄ alkyl group.

The linear or branched C₁ to C₁₄ alkyl group may include, for example, a methyl group, an ethyl group, an n-propyl group, an isopropyl group, an n-butyl group, an isobutyl group, a tert-butyl group, an n-pentyl group, an isopentyl group, a neopentyl group, a tert-pentyl group, a 2-methyl Butyl group, an n-hexyl group, an isohexyl group, a 3-methylpentyl group, an ethylbutyl group, an n-heptyl group, a 2-methylhexyl group, an n-octyl group, an isooctyl group, a tert-octyl group, a 2-ethylhexyl group, a 3-methylheptyl group, an n-nonyl group, an isononyl group, a 1-methyloctyl group, an ethylheptyl group, an n-decyl group, a 1-methylnonyl group, an n-undecyl group, a 1,1-dimethylnonil group, an n-dodecyl group, an n-tridecyl group, an n-tetradecyl group, and the like. In an embodiment, an n-butyl group, a 2-ethylhexyl group, or an n-dodecyl group is used in terms of adhesion and fundamental properties.

In an embodiment, the component (a1) may be selected from among methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, n-pentyl (meth)acrylate, isopentyl (meth)acrylate, 2-ethylhexyl (meth)acrylate, n-hexyl (meth)acrylate, n-heptyl (meth)acrylate, n-octyl (meth)acrylate, n-nonyl (meth)acrylate, n-decyl (meth)acrylate, n-dodecyl (meth)acrylate (n-lauryl (meth)acrylate), and the like. In an embodiment, n-butyl (meth)acrylate, 2-ethylhexyl (meth)acrylate, or n-dodecyl acrylate (n-lauryl acrylate) is used in terms of adhesive strength and low permittivity.

In the copolymer (a), the constituent unit derived from the component (a1) is present in an amount of about 15 wt % to about 55 wt % based on 100 wt % of the components (a1) to (a4). If the content of the constituent unit derived from the component (a1) is less than 15 wt %, the glass transition temperature of the copolymer (a) increases while deteriorating the step-filling properties and durability of the adhesive composition. If the content of the constituent unit derived from the component (a1) exceeds 55 wt %, the adhesive composition can suffer from deterioration in absorbency under moist heat conditions and in haze after moist heat durability testing. For example, the constituent unit derived from the component (a1) may be present in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. In an embodiment, the constituent unit derived from the component (a1) is present in an amount of about 20 wt % to about 50 wt %, and, in an embodiment, about 30 wt % to about 40 wt %.

In addition, the constituent unit derived from the component (a1) is present in an amount of about 20 wt % to about 60 wt % based on the sum of the constituent unit derived from the component (a1) and the constituent unit derived from the component (a2). If the content of the constituent unit derived from the component (a1) is less than about 20 wt %, the adhesive composition can suffer from deterioration in adhesive strength and processability. If the content of the constituent unit derived from the component (a1) exceeds about 60 wt %, an adhesive layer formed of the adhesive composition becomes too soft, causing deterioration in processability. For example, the constituent unit derived from the component (a1) may be present in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 58, 59, or 60 wt %.

(a2): Cyclic C₃ to C₁₄ Alkyl Group-Containing (Meth)acrylic Acid Ester Monomer.

The copolymer (a) includes the constituent unit derived from the component (a2): the cyclic C₃ to C₁₄ alkyl group-containing (meth)acrylic acid ester monomer (herein referred to as “component (a2)”). In an adhesive layer and a cured product thereof, the constituent unit derived from the component (a2) secures adhesive properties, durability, and low permittivity.

The component (a2) may be used alone or in combination thereof. The component (a2) may be prepared by a typical method known in the art or may be obtained from commercially available products.

The cyclic C₃ to C₁₄ alkyl group may include, for example, a cyclopropyl group, a cyclobutyl group, a cyclopentyl group, a cyclohexyl group, a cycloheptyl group, a cyclooctyl group, a 2-cyclopropylethyl group, a 2-cyclobutylethyl group, a 2-cyclopentylethyl group, a cyclohexylmethyl group, a 2-cyclohexylethyl group, a cycloheptylmethyl group, a 2-cyclooctylethyl group, a 3-methylcyclohexyl group, a 4-methylcyclohexyl group, a 4-ethylcyclohexyl group, a 2-methylcyclooctyl group, a 3-(3-methylcyclohexyl)propyl group, a 2-(4-methylcyclohexyl)ethyl group, a 2-(4-ethylcyclohexyl)ethyl group, a 2-(2-methylcyclooctyl)ethyl group, a decahydronaphthyl group, an adamantyl group, a dicyclopentanyl group, an isobornyl group, and the like. In an embodiment, a cyclohexyl group or an isobornyl group is used to secure durability and low permittivity.

In an embodiment, the component (a2) may be selected from among cyclopentyl (meth)acrylate, cyclohexyl (meth)acrylate, isobornyl (meth)acrylate, dicyclopentanyl (meth)acrylate, adamantyl (meth)acrylate, and the like. Preferably, isobornyl (meth)acrylate or cyclohexyl (meth)acrylate is used to secure durability and low permittivity. In an embodiment, isobornyl (meth)acrylate or cyclohexyl (meth)acrylate is used.

In the copolymer (a), the constituent unit derived from the component (a2) is present in an amount of about 10 wt % to about 55 wt % based on 100 wt % of the components (a1) to (a4). If the content of the constituent unit derived from the component (a2) is less than 10 wt %, the adhesive composition can suffer from deterioration in durability. If the content of the constituent unit derived from the component (a2) exceeds about 55 wt %, the glass transition temperature of the copolymer (a) increases while deteriorating the step-filling properties and durability of the adhesive composition. For example, the constituent unit derived from the component (a2) may be present in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. In an embodiment, the constituent unit derived from the component (a2) is present in an amount of 15 wt % to about 50 wt %, and, in an embodiment, about 20 wt % to about 45 wt %.

(a3): Hydroxyl Group-Containing (Meth)acrylic Acid Ester Monomer.

The copolymer (a) includes the constituent unit derived from the component (a3): the hydroxyl group-containing (meth)acrylic acid ester monomer (herein referred to as “component (a3)”). The constituent unit derived from the hydroxyl group-containing (meth)acrylic acid ester monomer (a3) has hydrophilicity. Accordingly, in an adhesive layer and a cured product thereof, the constituent unit derived from the component (a3) prevents or substantially prevents condensation (a phenomenon in which water droplets form on the surface of the adhesive layer) by improving moisture retention performance of a polymer. The component (a3) may be used alone or in combination thereof. The component (a3) may be prepared by a typical method known in the art or may be obtained from commercially available products.

The component (a3) is represented by the following Formula (2):

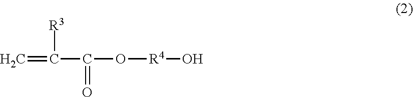

where R³ is a hydrogen atom or a methyl group and R⁴ is a bivalent organic group.

In an embodiment, the bivalent organic group is a C₁ to C₁₀ alkylene group, and, in an embodiment, a C₂ to C₆ alkylene group, to improve absorbency under the moist heat condition and haze after moist heat durability testing, without being limited thereto.

The C₁ to C₁₀ alkylene group may include, for example, any of a methylene group (—CH₂—), an ethylene group (—CH₂CH₂—), a trimethylene group (—CH₂CH₂CH₂—), a tetramethylene group (—CH₂CH₂CH₂CH₂—), a propylene group (—CH(CH₃)CH₂—), a pentamethylene group, a hexamethylene group, a pentamethylene group, an octamethylene group, a 2-ethylhexamethylene group (—CH₂CH(CH₂CH₃)CH₂CH₂CH₂CH₂—), a nonamethylene group, a decamethylene group, and the like. In an embodiment, an ethylene group or a tetramethylene group is used to improve haze after moist heat durability testing.

In an embodiment, the component (a3) may be selected from among 4-hydroxybutyl (meth)acrylate, 2-hydroxyethyl (meth)acrylate, hydroxymethyl (meth)acrylate, 2-hydroxypropyl (meth)acrylate, 1,4-cyclohexane dimethanol monoacrylate, and the like. In an embodiment, 4-hydroxybutyl (meth)acrylate or 2-hydroxyethyl (meth)acrylate is used to improve haze after moist heat durability testing.

In the copolymer (a), the constituent unit derived from the component (a3) is present in an amount of about 5 wt % to about 35 wt % based on 100 wt % of the components (a1) to (a4). If the content of the constituent unit derived from the component (a3) is less than about 5 wt %, the adhesive composition can suffer from deterioration in haze after moist heat durability testing. If the content of the constituent unit derived from the component (a3) exceeds about 35 wt %, the adhesive composition can suffer from deterioration in moist heat durability or step-filling properties. For example, the constituent unit derived from the component (a3) may be present in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %. In an embodiment, the constituent unit derived from the component (a3) is present in an amount of about 7 wt % to about 30 wt %, and, in an embodiment, about 10 wt % to about 25 wt %.

### Amide Group-Containing (Meth)acryl Monomer

The copolymer (a) includes the constituent unit derived from the component (a4): an amide group-containing (meth)acryl monomer (herein referred to as “component (a4)”). The constituent unit derived from the component (a4) has hydrophilicity. Accordingly, in an adhesive layer and a cured product thereof, the constituent unit derived from the component (a4) prevents or substantially prevents condensation (a phenomenon in which water droplets form on the surface of the adhesive layer) by improving moisture retention performance of a polymer. The component (a4) may be used alone or in combination thereof. The component (a4) may be prepared by a typical method known in the art or may be obtained from commercially available products.

The component (a4) is represented by the following Formula (3):

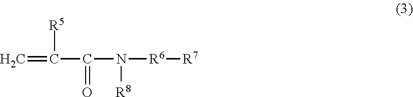

where R⁵ is a hydrogen atom or a methyl group, R⁶ is a bivalent organic group or a single bond, R⁷ is a hydrogen atom or a hydroxyl group, and Fe is a hydrogen atom or a C₁ to C₁₀ alkyl group.

In an embodiment, the bivalent organic group is a C₁ to C₁₀ alkylene group, and, in an embodiment, a C₂ to C₆ alkylene group, to improve haze after moist heat durability testing, without being limited thereto.

The C₁ to C₁₀ alkylene group may include, for example, the same alkylene group as described in Formula (2). In an embodiment, an ethylene group is used to improve haze after moist heat durability testing.

The C₁ to C₁₀ alkyl group may include, for example, the same alkyl group as described in Formula (2). In an embodiment, an ethyl group is used to improve after moist heat durability testing.

R⁷ and R⁸ may form a ring together.

In an embodiment, the amide group-containing (meth)acryl monomer may include any of N-hydroxymethyl (meth)acryl amide, N-hydroxyethyl (meth)acryl amide, N-(meth)acryloylmorpholine, N,N-dimethyl (meth)acryl amide, N,N-diethyl (meth)acryl amide, (meth)acryl amide, N-isopropyl (meth)acryl amide, N-t-butyl (meth)acryl amide, and the like. In an embodiment, N-(meth)acryloylmorpholine or N-hydroxyethyl (meth)acryl amide is used to secure durability while further improving haze after moist heat durability testing. These may be used alone or in combination thereof. Further, the component (a4) may be prepared by a typical method known in the art or may be obtained from commercially available products.

In the copolymer (a), the constituent unit derived from the component (a4) is present in an amount of about 5 wt % to about 35 wt % based on 100 wt % of the components (a1) to (a4). If the content of the constituent unit derived from the component (a4) is less than about 5 wt %, the adhesive composition can suffer from deterioration in haze after moist heat durability testing. If the content of the constituent unit derived from the component (a4) exceeds about 35 wt %, the adhesive composition can suffer from deterioration in moist heat durability or step-filling properties. For example, the constituent unit derived from the component (a4) is present in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %. In an embodiment, the constituent unit derived from the component (a4) is present in an amount of about 7 wt % to about 30 wt %, and, in an embodiment, about 10 wt % to about 25 wt %.

(a5): (Meth)acrylic Acid Ester Monomer Having a Radical Polymerizable Functional Group Other than the Components (a1), (a2), (a3) and (a4)

In addition to the components (a1) to (a4), the copolymer (a) may further include a constituent unit derived from (a5): a radical polymerizable functional group-containing (meth)acrylic acid ester monomer (herein referred to as “component (a5)”). In an adhesive layer and a cured product thereof, the constituent unit derived from the component (a5) reduces the permittivity of a polymer. The component (a5) may be prepared by a typical method known in the art or may be obtained from commercially available products.

The component (a5) may include, for example, any of an aromatic hydrocarbon group-containing (meth)acrylic acid ester monomer, a branched C₁₆ to C₃₆ alkyl group-containing (meth)acrylic acid ester monomer, an alkoxyalkyl group or alkylene oxide group-containing (meth)acrylic acid ester monomer, and the like.

The aromatic hydrocarbon group-containing (meth)acrylic acid ester monomer is represented by the following Formula (4):

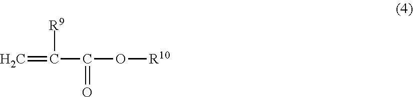

where R⁹ is a hydrogen atom or a methyl group and R¹⁹ is an aromatic hydrocarbon group.

In an embodiment, the aromatic hydrocarbon group is a C₆ to C₂₀ aromatic hydrocarbon group, for example, a benzene ring-containing group, such as a phenyl group and a benzylphenyl group, a naphthalene ring-containing group, and a biphenyl ring-containing group, without being limited thereto.

In an embodiment, the aromatic hydrocarbon group-containing (meth)acrylic acid ester monomer may include any of benzene ring-containing groups, such as benzyl (meth)acrylate, phenyl (meth)acrylate, benzylphenyl (meth)acrylate, o-phenylphenol (meth)acrylate, phenoxy (meth)acrylate, p-t-butylphenyl (meth)acrylate, phenoxyethyl (meth)acrylate, phenoxypropyl (meth)acrylate, phenoxydiethylene glycol (meth)acrylate, ethylene oxide-modified nonylphenol (meth)acrylate, ethylene oxide-modified cresol (meth)acrylate, phenolethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, polystyryl (meth)acrylate, and the like; naphthalene ring-containing groups, such as hydroxy ethylated β-naphthol (meth)acrylate, 2-naphthoethyl (meth)acrylate, 2-naphthoxyethyl (meth)acrylate, 2-(4-methoxy-1-naphthoxy)ethyl (meth)acrylate, and the like; and biphenyl ring-containing groups, such as biphenyl (meth)acrylate and the like.

In an embodiment, benzyl (meth)acrylate is used to secure durability and low permittivity.

The branched C₁₆ to C₃₆ alkyl group-containing (meth)acrylic acid ester monomer may include iso-cetyl (meth)acrylate, iso-stearyl (meth)acrylate, 2-decyltetradecaneyl (meth)acrylate(2-decyltetradecyl (meth)acrylate), and the like.

The alkoxyalkyl group or alkylene oxide group-containing (meth)acrylic acid ester monomer may include, for example, methoxyethyl (meth)acrylate, ethoxymethyl (meth)acrylate, ethoxyethyl (meth)acrylate, propoxyethyl (meth)acrylate, butoxyethyl (meth)acrylate, methoxypropyl (meth)acrylate, methoxybutyl (meth)acrylate; ethoxy-diethylene glycol (meth)acrylate, ethoxy-triethylene glycol (meth)acrylate, methoxy-triethylene glycol (meth)acrylate, methoxy-diethylene glycol (meth)acrylate, propoxy-diethylene glycol (meth)acrylate, methoxy-triethylene glycol (meth)acrylate, 2-ethylhexyl-diglycol (meth)acrylate (2-ethylhexyloxy-diethylene glycol (meth)acrylate), methoxy-polyethylene glycol (meth)acrylate (n=4 to 10), methoxydipropylene glycol (meth)acrylate, 2-ethylhexyl-diglycol acrylate, and the like.

In an embodiment, iso-stearyl (meth)acrylate, 2-decyltetradecaneyl (meth)acrylate, or 2-ethylhexyl-diglycol (meth)acrylate is used to secure low permittivity.

In an embodiment, in the copolymer (a), the constituent unit derived from the component (a5) is present in an amount of about 8 parts by weight to about 45 parts by weight, and, in an embodiment, about 10 parts by weight to about 40 parts by weight, based on 100 parts by weight of the components (a1) to (a4). Within this range, the adhesive composition exhibits good properties in terms of adhesion, low permittivity, and durability. For example, the constituent unit derived from the component (a5) may be present in an amount of about 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 parts by weight.

### Morphology of Main Component

According to the present invention, the main component may consist of the copolymer (a) or may be present in a so-called polymer syrup morphology including the copolymer (a) and an un-reacted monomer. In an embodiment, the main component is provided in the form of the polymer syrup morphology including the copolymer (a) and the unreacted monomer (monomers of the components (a1) to (a4) (component (a5), as needed)) in terms of easy formation of an adhesive layer according to the present invention, efficient achievement of effects of the present invention, and the like. Herein, a method of preparing the polymer syrup will be described.

The copolymer (a) may be prepared through a typical polymerization method using a polymerization initiator, such as solution polymerization, bulk polymerization, emulsion polymerization, suspension polymerization, reverse phase suspension polymerization, thin film polymerization, and spray polymerization, without being limited thereto. Examples of a polymerization control method may include adiabatic polymerization, temperature controlled polymerization, and isothermal polymerization. The polymerization initiator may be a thermal polymerization initiator or a photopolymerization initiator. Further, in addition to a method of initiating polymerization with the polymerization initiator, polymerization may be initiated through irradiation with actinic energy, such as radiation, electron beams, and ultraviolet rays. In an embodiment, bulk polymerization using a photopolymerization initiator is used in terms of easy regulation of molecular weight and reduction in impurities.

For bulk polymerization using a photopolymerization initiator, for example, raw monomers of the copolymer (a) and the photopolymerization initiator are mixed and irradiated with actinic energy at a reaction start temperature of about 20° C. to about 35° C. under a nitrogen atmosphere. In this process, the copolymer (a) may be obtained by stopping reaction through introduction of air into a reaction system at a stage in which the temperature in the reaction system increases about 5° C. to about 15° C. from the reaction start temperature. Here, it is not necessary to react all of the raw monomers and the reaction may be stopped when a target weight average molecular weight is reached. Since the unreacted raw monomers, that is, the components (a1) to (a5), are solvents that dissolve the copolymer (a), the polymer syrup may be obtained through this process.

Examples of active energy applicable to bulk polymerization may include, for example, UV light, laser beams, α-rays, β-rays, γ-rays, X-rays, electron beams, and the like. In an embodiment, UV light is used in terms of controllability, handling and costs. In an embodiment, UV light having a wavelength of about 200 nm to about 400 nm is used. UV light may be irradiated from a light source, such as a high-pressure mercury lamp, a microwave excitation lamp, a chemical lamp, and a black light. In an embodiment, the light source has an irradiance of about 1.0 mW/cm² to about 50 mW/cm².

Examples of the photopolymerization initiator may include, for example, acetophenones, such as acetophenone, 3-methylacetophenone, benzyl dimethyl ketal, 2,2-dimethoxy-1,2-diphenylethan-1-one, 1-(4-isopropylphenyl)-2-hydroxy-2-methylpropane-1-one, 2-methyl-1-[4-(methylthio)phenyl]-2-morpholinopropane-1-one, and 2-hydroxy-2-methyl-1-phenylpropane-1-one; benzophenones, such as benzophenone, 4-chlorobenzophenone, and 4,4′-diaminobenzophenone; benzoin ethers, such as benzoin propyl ether and benzoin ethyl ether; thioxanthones, such as 4-isopropyl thioxanthone and the like; 1-hydroxycyclohexyl-phenyl ketone, xanthone, fluorenone, camphorquinone, benzaldehyde, and anthraquinone. These photopolymerization initiators may be used alone or in combination thereof.

The photopolymerization initiator may be obtained from commercially available products, for example, Omnirad® 184, 819, 907, 651, 1700, 1800, 819, 369, 261, 1173, TPO (IGM Resins B.V.), ESACURE® KIP150, TZT (IGM Resins B.V.), KAYACURE® BMS and DMBI (products of Nippon Kayaku Co., Ltd.), and the like.

In an embodiment, the photopolymerization initiator is present in an amount of about 0.0005 parts by weight to about 1 part by weight, and, in an embodiment, about 0.002 parts by weight to about 0.5 parts by weight, relative to 100 parts by weight of the raw monomers.

In an embodiment, in the polymer syrup, the copolymer (a) is present in an amount of about 3 wt % to about 20 wt %, for example, about 3, 4, 5, 6, 7, 8, 9, 10, 11, 12, 13, 14, 15, 16, 17, 18, 19, or 20 wt %, and, in an embodiment, about 5 wt % to about 15 wt %, based on the total weight of the polymer syrup in terms of viscosity of the adhesive composition.

According to the present invention, the composition of the copolymer (a) (the content of each monomer) and the composition of the components (a1) to (a5) may be the same of different. In an embodiment, these compositions are the same to secure good properties of an adhesive layer and a cured product thereof.

According to an embodiment of the present invention, the copolymer (a) has a weight average molecular weight (Mw) of about 300,000 to about 3,000,000, and, in an embodiment, about 500,000 to about 2,500,000. Within this range, the adhesive composition can secure good coatability upon formation of an adhesive layer or good durability of the adhesive layer. The weight average molecular weight (Mw) of the copolymer (a) may be measured by a method set forth in examples.

According to an embodiment of the present invention, the copolymer (a) has a glass transition temperature (Tg) of about −40° C. to about 20° C., for example, about −40, −35, −30, −25, −20, −15, −10, −5, 0, 5, 10, 15, or 20° C., and, in an embodiment, about −20° C. to about 10° C. Within this range, the adhesive composition exhibits good properties in terms of durability, step-filling properties, and processability. The glass transition temperature (Tg) of the copolymer (a) is calculated by a Fox equation based on the glass transition temperature of a homopolymer of each of the monomers used therefor.

[Chain Transfer Agent]

The chain transfer agent stops elongation of a growth polymer by receiving radicals from a chain of the growth polymer, and the chain transfer agent receiving the radicals serves to initiate polymerization again by attacking the monomers. According to embodiments of the present invention, the chain transfer agent improves the step-filling properties.

The chain transfer agent may include, for example, primary or secondary mono-functional thiol compounds or polyfunctional thiol compounds, thioglycolic acid compounds, thiocarbonyl compounds, and mercaptopropionic acid compounds.

In an embodiment, the chain transfer agent may include any of β-mercaptopropionic acid, 2-ethylhexyl-3-mercaptopropionate, n-octyl-3-mercaptopropionate, methoxybutyl-3-mercaptopropionate, stearyl-3-mercaptopropionate, trimethylolpropane tris(3-mercaptopropionate), tris-[(3-mercaptopropionyloxy)-ethyl]-isocyanurate, pentaerythritol tetrakis(3-mercaptopropionate), tetraethylene glycol bis(3-mercaptopropionate), dipentaerythritol hexakis(3-mercaptopropionate), 3,3′-thiodipropionic acid, dithiopropionic acid, laurylthiopropionic acid, thioglycolic acid, ammonium thioglycolic acid, monoethanolamine thioglycolic acid, diammonium thioglycolic acid, and the like. The chain transfer agent may be obtained from commercially available products, for example, BMPA, EHMP, NOMP, MBMP, STMP, TMMP, TEMPIC, PEMP, EGMP-4, DPMP, TDPA, DTDPA, LTPA, ATG, TG-MEA, DATG (SC Organic chemical Co., Ltd.). These may be used alone or in combination thereof.

The chain transfer agent may be present in an amount of about 0.01 parts by weight to about 5 parts by weight, relative to 100 parts by weight of the main component. If the content of the chain transfer agent is less than about 0.01 parts by weight, the adhesive composition can have an uneven molecular weight in an adhesive layer formed therefrom, making it difficult to control curing reaction and to achieve stable formation of an adhesive layer having sufficient step-filling properties. If the content of the chain transfer agent exceeds about 5 parts by weight, the adhesive composition can have too low a molecular weight, thereby causing deterioration in durability. For example, the chain transfer agent may be present in an amount of about 0.01, 0.02, 0.03, 0.04, 0.05, 0.06, 0.07, 0.08, 0.09, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, or 5 parts by weight. In an embodiment, the chain transfer agent is present in an amount of about 0.01 parts by weight to about 3 parts by weight, and, in an embodiment, about 0.05 parts by weight to 1 part by weight, and, in an embodiment, about 0.05 parts by weight to about 0.1 parts by weight, relative to 100 parts by weight of the main component. Within this range, the adhesive composition can stably form an adhesive layer having sufficient step-filling properties while securing durability.

### Crosslinking Agent

The adhesive composition according to an embodiment of the present invention further includes a crosslinking agent. The crosslinking agent forms a crosslinked structure through reaction with the copolymer (a). In the adhesive composition, the crosslinking agent improves adhesion and durability.

In an embodiment, the crosslinking agent includes at least one selected from the group consisting of an isocyanate compound, a carbodiimide compound, an oxazoline compound, an epoxy compound, a multifunctional (meth)acrylic acid ester monomer, a multifunctional allyl monomer, and peroxides thereof. Next, each of these crosslinking agents will be described in further detail.

### Isocyanate Compound

Examples of the isocyanate compound used as the crosslinking agent may include aromatic diisocyanates, such as dimeric diisocyanate, 2,4-toluene diisocyanate (2,4-TDI), 2,6-toluene diisocyanate (2,6-TDI), 4,4′-diphenylmethane diisocyanate (4,4′-MDI), 2,4′-diphenylmethanediisocyanate (2,4′-MDI), 1,4-phenylene diisocyanate, xylylene diisocyanate (XDI), tetramethylxylene diisocyanate (TMXDI), toluidine diisocyanate (TODD, and 1,5-naphthalene diisocyanate (NDI); aliphatic diisocyanates, such as allyl isocyanate, hexamethylene diisocyanate (HDI), trimethyl hexamethylene diisocyanate (TMHDI), lysine diisocyanate, and norbornene diisocyanate (NBDI); alicyclic diisocyanates, such as trans-cyclohexane-1,4-diisocyanate, isophorone diisocyanate (IPDI), H6-XDI (hydrogenated XDI), and H12-MDI (hydrogenated MDI); carbodiimide-modified diisocyanates of the diisocyanate; and isocyanurate-modified diisocyanates thereof. Adducts of polyol compounds of the isocyanate compound with trimethylol propane, polytetramethylene ether glycol (PTMG), polypropylene glycol (PPG), and the like, or burets or isocyanurates of these isocyanate compound may be used.

These isocyanate compounds may be prepared by any typical method known in the art or may be obtained from any suitable commercially available products.

Examples of the commercially available product may include CORONATE® L, CORONATE® HL, CORONATE® HX, CORONATE® 2030, CORONATE® 2031 (Toso Co., Ltd.), TAKENATE® D-102, TAKENATE® D-110N, TAKENATE® D-200, TAKENATE® D-202 (Mitsui Kagaku Co., Ltd.), DURANATE® 24A-100, DURANATE® TPA-100, DURANATE® TKA-100, DURANATE® P301-75E, DURANATE® E402-90T, DURANATE® E405-80T, DURANATE® TSE-100, DURANATE® D-101, DURANATE® D-201 (Asahi Kasei Chemical Co., Ltd.), SUMIDULE® N-75, N-3200, and N-3300 (Sumika Bayer Urethane Co., Ltd.), SANPRENE® P-6090 (PTMG/MDI), SANPRENE® P-663L (PTMG/TDI), SANPRENE® P-664 (PTMG/TDI), SANPRENE® P-665 (PTMG/TDI), SANPRENE® P-667 (PTMG/TDI), SANPRENE® P-868 (PTMG/HMDI), SANPRENE® P-870 (PTMG/HMDI), SANPRENE® C-810 (PPG/TDI) (Sanyo Kasei Chemical Co., Ltd.), and TAIC (Mitsubishi Chemical Co., Ltd.), without being limited thereto.

The isocyanate compound may be an unblocked isocyanate compound. In an embodiment, the isocyanate compound may be used in the form of a blocked isocyanate compound obtained by reacting an isocyanate compound with a blocking agent protecting an isocyanate group. The blocked isocyanate compound may be prepared by any typical method known in the art or may be obtained from any suitable commercially available products. Examples of the block isocyanate compound may include DURANATE® MF-B60X (blocked 1,6-hexamethylene diisocyanate), DURANATE® MF-K60X (blocked 1,6-hexamethylene diisocyanate) (Asahi Kasei Chemical Co., Ltd.), CORONATE® AP-M, 2503, 2507, 2513, 2515, MILLIONATE® MS-50 (Toso Co., Ltd.), TAKENATE® B-830 (blocked toluene diisocyanate), B-815N (blocked 4,4′-methylene bis(cyclohexylisocyanate)), B-842N (blocked 1,3-bis(isocyanatomethyl)cyclohexane), B-846N (blocked 1,3-bis(isocyanatomethyl)cyclohexane), B-874N (blocked isophorone diisocyanate), B-882N (blocked 1,6-hexamethylene diisocyanate) (Mitsui Kagaku Co., Ltd.), BURNOCK® D-500 (blocked toluene diisocyanate), D-550 (blocked 1,6-hexamethylene diisocyanate) (DIC Co., Ltd.), ELASTRON® BN-P17 (blocked 4,4′-diphenylmethane diisocyanate), BN-04, BN-08, BN-44, BN-45 (blocked urethane-modified polyisocyanate) (Dai-Ichi Kogyo Seiyaku Co., Ltd.), and the like. In an embodiment, DURANATE® MF-K60X is used.

In an embodiment, in terms of further improvement in durability of the adhesive composition, the isocyanate compound is used in the form of an unblocked isocyanate compound.

### Carbodiimide Compound

According to the present invention, any carbodiimide compound may be used as the crosslinking agent. For example, the carbodiimide compound may be a high-molecular weight polycarbodiimide obtained by decarboxylative condensation of diisocyanate in the presence of a carbodiimidization catalyst, without being limited thereto.

Examples of the diisocyanate for decarboxylative condensation may include 4,4′-diphenylmethane diisocyanate, 3,3′-dimethoxy-4,4′-diphenylmethane diisocyanate, 3,3′-dimethyl-4,4′-diphenylmethane diisocyanate, 4,4′-diphenyl ether diisocyanate, 3,3′-dimethyl-4,4′-diphenyl ether diisocyanate, 2,4-toluene diisocyanate, 2,6-toluene diisocyanate, 1-methoxyphenyl-2,4-diisocyanate, isophorone diisocyanate, 4,4′-dicyclohexylmethane diisocyanate, and tetramethylxylylene diisocyanate.

Examples of the carbodiimidization catalyst used in decarboxylative condensation may include phosphorene oxides, such as 1-phenyl-2-phosphorene-1-oxide, 3-methyl-2-phosphorene-1-oxide, 1-ethyl-3-methyl-2-phosphorene-1-oxide, 1-ethyl-2-phosphorene-1-oxide, or 3-phosphorene isomers thereof.

The high-molecular weight polycarbodiimide may be prepared by any typical method known in the art or may be obtained from any suitable commercially available products. Examples of the commercially available products may include CARBODILITE® series (Nisshinbo Chemical Co., Ltd.). In an embodiment, CARBODILITE® V-01, V-03, V-05, V-07, or V-09 is used due to good compatibility with an organic solvent.

[Oxazoline Compound]

According to the present invention, any oxazoline compound may be used as the crosslinking agent. In an embodiment, the oxazoline compound is an oxazoline group-containing acrylic/styrene polymer which includes a main chain composed of an acrylic main backbone or styrene main backbone and has an oxazoline group in a side chain. In an embodiment, the oxazoline compound is an oxazoline group-containing acrylic polymer which includes a main chain composed of an acrylic main backbone and has an oxazoline group in a side chain.

Examples of the oxazoline group may include a 2-oxazoline group, a 3-oxazoline group, and a 4-oxazoline group. Particularly, a 2-oxazoline group is preferred.

The oxazoline group-containing polymer may further contain a polyoxyalkylene group in addition to the oxazoline group.

Examples of the oxazoline group-containing polymer may include oxazoline group-containing acrylic polymers, such as EPOCROS® WS-300, EPOCROS® WS-500, and EPOCROS® WS-700 (Nippon Shokubai Co., Ltd.), and the like, and oxazoline group-containing acrylic/styrene polymers, such as EPOCROS® K-1000 series and EPOCROS® K-2000 series (Nippon Shokubai Co., Ltd.), and the like.

### Epoxy Compound

According to the present invention, any suitable epoxy compound known in the art may be used as the crosslinking agent. Examples of commercially available epoxy compounds may include TETRAD-C, TETRAD-X (Mitsubishi Gas Kagaku Co., Ltd.), ADEKARESIN EPU series, ADEKARESIN EPR series (ADEKA Co., Ltd.), and CELLOXIDE (Daicel Co., Ltd.). In an embodiment, any of these liquid epoxy resins are used to facilitate a mixing operation in preparation of the adhesive compositions for optical films.

### Multifunctional (Meth)acrylic Acid Ester Monomer

The multifunctional (meth)acrylic acid ester monomer capable of being used as the crosslinking agent according to the present invention includes multiple (two or more) radical polymerizable functional groups. Examples of the monomers may include a hydrocarbon or hydrocarbon ether-based multifunctional monomer. The hydrocarbon or hydrocarbon ether-based multifunctional monomer is a compound obtained by (meth)acrylation of a hydroxyl group of a polyhydric alcohol having a C₁₀ to C₁₀₀ hydrocarbon group or hydrocarbon ether group as a main backbone. In an embodiment, this compound is used in terms of improvement in adhesion by crosslinking. Examples of the hydrocarbon group of the polyhydric alcohol include a linear or branched aliphatic hydrocarbon group, an aromatic hydrocarbon group, an alicyclic hydrocarbon group, and a hydrocarbon group obtained through combination of these hydrocarbon groups. Examples of the hydrocarbon ether group include those obtained by etherification of the hydrocarbon group. Further, examples of the polyhydric alcohol having a hydrocarbon ether group as the main backbone may include a compound obtained by adding a C₂ to C₄ alkylene oxide to the polyhydric alcohol (addition number: 1 to 30). In addition, polyalkylene glycol (addition number 1 to 30), which can be obtained from the C₂ to C₄ alkylene oxide, may be used.

Hydrocarbon-based bifunctional monomers may include, for example, alkylene glycol di(meth)acrylates, such as ethylene glycol di(meth)acrylate, 1,3-butylene glycol di(meth)acrylate, 1,4-butanediol di(meth)acrylate, 1,6-hexanediol di(meth)acrylate, neopentyl glycol di(meth)acrylate, and the like; di(meth)acrylates of diol compounds, such as cyclohexane dimethanol di(meth)acrylate, tricyclodecane dimethanol di(meth)acrylate (dimethylol-tricyclodecane di(meth)acrylate), and the like; and di(meth)acrylates of diol compounds having an aromatic hydrocarbon group, such as bisphenol-A di(meth)acrylate, and the like.

Hydrocarbon ether-based bifunctional monomers may include, for example, di(meth)acrylates of compounds obtained by adding an alkylene oxide to the alkylene glycol or diol compounds mentioned in the hydrocarbon-based bifunctional monomer, such as alkoxylated hexanediol di(meth)acrylate, alkoxylated cyclohexane dimethanol di(meth)acrylate, alkoxylated di(meth)acrylate, alkoxylated neopentyl glycol di(meth)acrylate, alkoxylated bisphenol-A di(meth)acrylate, and the like. Further, the hydrocarbon ether-based bifunctional monomers may include, for example, polyalkylene glycol di(meth)acrylates or dioxane glycol di(meth)acrylates, such as diethylene glycol di(meth)acrylate, triethylene glycol di(meth)acrylate, tetraethylene glycol di(meth)acrylate, polyethylene glycol di(meth)acrylate, tripropylene glycol di(meth)acrylate, dipropylene glycol di(meth)acrylate, and the like.

Further, hydrocarbon or hydrocarbon ether-based trifunctional or tetra-functional monomers may include, for example, tri(meth)acrylates or tetra(meth)acrylates of triol or tetraol compounds or tri(meth)acrylates or tetra(meth)acrylates of compounds obtained by adding an alkylene oxide to the triol or tetraol compounds, such as trimethylol propane tri(meth)acrylate, pentaerythritol tri(meth)acrylate, glyceryl tri(meth)acrylate, pentaerythritol tetra(meth)acrylate, trimethylol propane tetra(meth)acrylate, and the like.

Further, hydrocarbon or hydrocarbon ether-based hexa-functional monomers may include, for example, dipentaerythritol hexa(meth)acrylate.

Further, examples of monomers other than the hydrocarbon or hydrocarbon ether-based monomers may include polyester poly(meth)acrylate and epoxy (meth)acrylate, which have two or more (meth)acryloyl groups at a terminal thereof.

### Multifunctional Allyl Monomer

The multifunctional allyl monomer capable of being used as the crosslinking agent according to the present invention is a monomer having at least one allyl group and multiple (two or more) radical polymerizable functional groups including an allyl group. Examples of the multifunctional allyl monomer may include allyl (meth)acrylate, diallyl phthalate (DAP), trimethylol propane diallyl ether, pentaerythritol triallyl ether, triallyl isocyanurate, and the like.

### Peroxide

According to the present invention, any suitable peroxides known in the art may be used as the crosslinking agent. In an embodiment, a peroxide having a one-minute half-life temperature of 80° C. to 160° C. is used as the crosslinking agent in terms of productivity or stability. In an embodiment, a peroxide having a one-minute half-life temperature of 80° C. to 140° C. is used as the crosslinking agent. In an embodiment, the peroxide used as the crosslinking agent has a one-minute half-life temperature of about 80° C. to about 125° C., and, in an embodiment, about 90° C. to about 125° C. The half-life of a peroxide is an index representing a decomposition rate of the peroxide, and means a period of time until a remaining amount of the peroxide reaches one-half. A decomposition temperature or half-life of a peroxide at a certain temperature is described in a manufacturer's catalog and the like, for example, “Organic Peroxide Catalog, 9th edition (May, 2003)”, NOF Corporation.

Examples of such peroxides may include diisopropyl peroxydicarbonate (88.3° C., and, herein, the temperature in parentheses represents the half-life temperature for one minute), di(2-ethylhexyl)peroxydicarbonate (90.6° C.), bis(4-t-butylcyclohexyl)peroxydicarbonate (92.1° C.), di-sec-butyl peroxydicarbonate (92.4° C.), t-butyl peroxyneodecanoate (103.5° C.), t-hexyl peroxypivalate (109.1° C.), t-butyl peroxypivalate (110.3° C.), dilauroyl peroxide (116.4° C.), bis-n-octanoyl peroxide (117.4° C.), 1,1,3,3-tetramethyl butyl peroxy-2-ethylhexanoate (124.3° C.), di(4-methylbenzoyl) peroxide (128.2° C.), dibenzoyl peroxide (130.0° C.), a mixture of dibenzoyl peroxide, benzoyl m-methyl benzoyl peroxide, and m-toluoyl peroxide (131.1° C.), t-butyl epoxy butyrate (136.1° C.), and the like. In an embodiment, any of diisopropyl peroxy dicarbonate, bis(4-t-butylcyclohexyl)peroxy dicarbonate, and t-butylperoxy neodecanoate are used. Particularly, although these can be used alone, these may be used in combination thereof in terms of regulation of reactivity. In an embodiment, a combination of di(4-t-butylcyclohexyl) peroxy dicarbonate and dilauroyl peroxide is used.

The peroxide may be prepared by any typical method known in the art or may be obtained from any suitable commercially available products. Examples of the commercially available products may include Peroyl® IB (85.1° C.), Percumyl® ND (94.0° C.), Peroyl® NPP (94.0° C.), Peroyl® IPP (88.3° C.), Peroyl® SBP (92.4° C.), Perocta® ND (92.4° C.), Peroyl® TCP (92.1° C.), Peroyl OPP (90.6° C.), Perhexyl® ND (100.9° C.), Perbutyl® ND (103.5° C.), Perbutyl® NHP (104.6° C.), Perhexyl® PV (109.1° C.), Perbutyl® PV (110.3° C.), Peroyl® 355 (112.6° C.), Peroyl® L (116.4° C.), Perocta® 0 (124.3° C.), Peroyl® SA (131.8° C.), Perhexa® 250 (118.8° C.), Perhexyl® 0 (132.6° C.), Nyper® PMB (128.2° C.), Perbutyl® 0 (134.0° C.), Nyper® BMT (131.1° C.), Nyper® BW (130.0° C.), Nyper® BMT-K40 (131.1° C.), Nyper® BMT-M (131.1° C.), Perhexa® MC (142.1° C.), Perhexa® TMH (147.1° C.), Perhexa® HC (149.2° C.), Perhexa® C (153.8° C.), Pertetra® A (153.8° C.), Perhexyl® I (155.0° C.), Perbutyl® L (159.4° C.), Perbutyl® I (158.8° C.), Perhexa® 25Z (158.2° C.), Perbutyl® A (159.9° C.), and Perhexa® 22 (159.9° C.) (all available from NOF Corporation).

According to the present invention, these crosslinking agents may be used alone or in combination thereof. In combination of two or more types of crosslinking agents, two or more types of the same series of crosslinking agents (for example, two types of isocyanate compounds) may be combined. In an embodiment, one or more different types of crosslinking agents (for example, one isocyanate compound and one peroxide) may be combined.

In the adhesive composition for optical films according to the present invention, the crosslinking agent may be present in an amount of about 0.01 parts by weight to about 5 parts by weight, relative to 100 parts by weight of the main component. For example, the crosslinking agent may be present in an amount of about 0.01, 0.02, 0.03, 0.04, 0.05, 0.06, 0.07, 0.08, 0.09, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, or 5 parts by weight. In an embodiment, the crosslinking agent is present in an amount of about 0.02 parts by weight to about 4 parts by weight, and, in an embodiment, about 0.03 parts by weight to about 3 parts by weight. In an embodiment, the crosslinking agent is present in an amount of about 0.05 parts by weight to about 3 parts by weight. Within this range of the crosslinking agent, the adhesive composition can secure durability and step-filling properties.

### Silane Coupling Agent

In an embodiment, the adhesive composition for optical films according to the present invention further includes a silane coupling agent. The silane coupling agent (D) improves durability of the adhesive composition or improves adhesion of the adhesive composition to glass as an adherend. As used herein, “silane coupling agent” refers to a compound that is free from a siloxane bond (Si—O—Si—) and has at least two reactive groups per molecule.

Any silane coupling agent may be used in the adhesive composition according to the present invention. Specifically, the silane coupling agent may include, for example, 3-glycidoxypropyltrimethoxysilane, 3-glycidoxypropyltriethoxysilane, methyltrimethoxysilane, methyltrimethoxysilane, dimethyldimethoxysilane, trimethylmethoxysilane, n-propyltrimethoxysilane, ethyltrimethoxysilane, diethyldiethoxysilane, n-butyltrimethoxysilane, n-hexyltriethoxysilane, n-octyltrimethoxysilane, phenyltrimethoxysilane, diphenyldimethoxysilane, cyclohexylmethyldimethoxysilane, vinyltrichlorosilane, vinyltrimethoxysilane, vinyltriethoxysilane, vinyl tris(β-methoxyethoxy)silane, β-(3,4-epoxycyclohexyl)ethyltrimethoxysilane, 3-glycidoxypropylmethyldiethoxysilane, γ-glycidoxypropyltrimethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-β-(aminoethyl)-γ-aminopropylmethyldimethoxysilane, N-β-(aminoethyl)-γ-aminopropyltrimethoxysilane, aminopropyltrimethoxysilane, N-β-(aminoethyl)-γ-aminopropyltriethoxysilane, γ-aminopropyltrimethoxysilane, γ-am inopropyltriethoxysilane, N-phenyl-γ-aminopropyltrimethoxysilane, γ-chloropropyltrimethoxysilane, γ-mercaptopropyltrimethoxysilane, γ-mercaptopropylmethyldimethoxysilane, mercaptopropylmethyldimethoxysilane, bis-(3-[triethoxysilyl]propyl)tetrasulfide, and γ-isocyanatopropyltriethoxysilane, without being limited thereto. In addition, the silane coupling agent may be a silane coupling agent having a functional group, such as an epoxy group (glycidoxy group), an amino group, a mercapto group, and a (meth)acryloyl group, and a silane coupling agent containing a functional group reactive with these functional groups. Further, the silane coupling agent may be a hydrolyzable silyl group-containing compound obtained by reacting the silane coupling agent with another coupling agent and polyisocyanate in a ratio (e.g., a predetermined ratio) in terms of functional group content.

The silane coupling agent (D) may be prepared by any typical method known in the art, or may be obtained from any suitable commercially available products. Examples of the commercially available products may include KBM-303, KBM-403, KBE-402, KBE-403, KBE-502, KBE-503, KBM-5103, KBM-573, KBM-802, KBM-803, KBE-846, KBE-9007 (all available from Shin-Etsu Kagaku Kogyo Co., Ltd.).

These silane coupling agents may be used alone or in combination thereof.

In the adhesive composition according to the present invention, the content of the silane coupling agent is not particularly limited. In an embodiment, the silane coupling agent is present in an amount of about 0.001 parts by weight to about 5 parts by weight relative to 100 parts by weight of the main component. In an embodiment, the silane coupling agent is present in an amount of about 0.001 parts by weight to about 4 parts by weight, and, in an embodiment, about 0.01 parts by weight to about 3 parts by weight. When the content of the silane coupling agent is about 0.001 parts by weight or more, the adhesive composition can exhibit improved durability even under harsh conditions. When the content of the silane coupling agent is about 5 parts by weight or less, the adhesive composition can be prevented or substantially prevented from suffering from heat bubbling, which is likely to occur in a low-molecular weight compound.

### High Softening Point Resin

According to the present invention, the adhesive composition may further include a high softening point resin having a softening point of about 60° C. to about 200° C. (herein, also referred to as “high softening point resin”). With the high softening point resin, the adhesive composition can become hard to some degree at room temperature and soften (soft) at high temperature. By addition of the high softening point resin, the adhesive composition can have such characteristics and can secure durability.

According to an embodiment of the present invention, the high softening point resin has a softening point of about 60° C. to about 200° C. in terms of efficient exhibition of the advantageous effects. Accordingly, any typical high softening point resin known in the art may be used. Examples of the high softening point resins may include petroleum resins, such as aliphatic petroleum resins, alicyclic hydrocarbon resins, aromatic petroleum resins, fully hydrogenated aliphatic petroleum resins, fully hydrogenated alicyclic hydrocarbon resins, fully hydrogenated aromatic petroleum resins, partially hydrogenated aliphatic petroleum resins, partially hydrogenated alicyclic hydrocarbon resins, and partially hydrogenated aromatic petroleum resins, aromatic hydrocarbon resins, aliphatic saturated hydrocarbon resins, terpene resins, terpene-phenol resins, hydrogenated terpene resins, coumarone-indene resins, rosin-based resins (also referred to as “rosins” or “rosin derivatives”) such as rosin acid, polymerized rosin acid, and rosin ester resins (rosin acid esters), epoxy resins, phenol resins, oil-soluble phenol resins, and modified products thereof. These high softening point resins may be used alone or in combination thereof. In an embodiment, any of alicyclic hydrocarbon resins, terpene-phenol resins, and terpene resins are used in terms of compatibility with the (meth)acrylate copolymer (A). In an embodiment, the high softening point resin is a rosin ester rein in terms of compatibility with the other components of the adhesive composition and in terms of securing transparency when the adhesive composition is used in an optical film.

The high softening point resin may be prepared by any typical method known in the art, or may be obtained from any suitable commercially available products.

Examples of the commercially available products may include Pinecrystal® KR-85 (softening point: 80° C. to 87° C., hereinafter, the temperature in parentheses represents the softening point), Pinecrystal® KR-612 (80° C. to 90° C.), Pinecrystal® KR-614 (84° C. to 94° C.), Pinecrystal® KE-100 (95° C. to 105° C.), Pinecrystal® KE-311 (90° C. to 100° C.), Pinecrystal® PE-590 (90° C. to 100° C.), Pinecrystal® KE-359 (94° C. to 104° C.), Pinecrystal® KE-604 (124° C. to 134° C.), Pinecrystal® KR-120 (110° C. to 130° C.), Pinecrystal® KR-140 (130° C. to 150° C.), Pinecrystal® KR-614 (84° C. to 94° C.), Pinecrystal® D-6011 (84° C. to 99° C.), and Pinecrystal® KR-50M (145° C. to 160° C.) (all available from Arakawa Chemical Industry Co., Ltd.). These are super-pale rosins, which are suitable for use in optical applications requiring transparency.

Other examples of the rosin ester resins may include Super Ester A-75 (70° C. to 80° C.), Super Ester A-100 (95° C. to 105° C.), Super Ester A-115 (108° C. to 120° C.), Super Ester A-125 (120° C. to 130° C.), and Tamanol® 460 (182° C. to 192° C.) (all available from Arakawa Chemical Industries, Ltd.).

Examples of the alicyclic hydrocarbon resins may include Arkon® P-90 (85° C. to 95° C.), Arkon® P-100 (95° C. to 105° C.), Arkon® P-115 (110° C. to 120° C.), Arkon® P-125 (120° C. to 130° C.), Arkon® P-140 (135° C. to 145° C.), Arkon® M-90 (85° C. to 95° C.), Arkon® M-100 (95° C. to 105° C.), Arkon® M-115 (110° C. to 120° C.), and Arkon® M-135 (130° C. to 140° C.) (all available from Arakawa Chemical Industries, Ltd.).

Examples of the terpene-phenol resins may include Tamanol® 803L (145° C. to 160° C.), Tamanol® 901 (125° C. to 135° C.), (all available from Arakawa Chemical Industries, Ltd.), YS POLYSTER® U130 (125° C. to 135° C.), YS POLYSTER® T115 (110° C. to 120° C.), (125° C. to 135° C.), YS POLYSTER® T160 (155° C. to 165° C.), YS POLYSTER® T145 (140° C. to 150° C.), YS POLYSTER® T130 (125° C. to 135° C.), YS POLYSTER® T115 (110° C. to 120° C.), YS POLYSTER® T100 (95° C. to 105° C.), YS POLYSTER® T80 (75° C. to 85° C.), YS POLYSTER® S145 (140° C. to 150° C.), YS POLYSTER® G150 (145° C. to 155° C.), YS POLYSTER® G125 (120° C. to 130° C.), YS POLYSTER® N125 (120° C. to 130° C.), YS POLYSTER® K125 (120° C. to 130° C.), and YS POLYSTER® TH130 (125° C. to 135° C.) (all available from Yasuhara Chemical Co., Ltd.).

Examples of the terpene resins may include YS RESIN® PX1250 (120° C. to 130° C.), YS RESIN® PX1150 (110° C. to 120° C.), YS RESIN® PX1000 (95° C. to 105° C.), YS RESIN® PX800 (75° C. to 85° C.), YS RESIN® PX1150N (110° C. to 120° C.), YS RESIN® TO125 (120° C. to 130° C.), YS RESIN® TO115 (110° C. to 120° C.), YS RESIN® TO105 (100° C. to 110° C.), and YS RESIN® TO85 (80° C. to 90° C.) (all available from Yasuhara Chemical Co., Ltd.).

In the adhesive composition for optical films according to the present invention, the content of the high softening point resin is not particularly limited. In an embodiment, the high softening point resin is present in an amount of about 0.1 parts by weight to about 30 parts by weight relative to 100 parts by weight of the main component. For example, the high softening point resin may be present in an amount of about 0.1, 0.5, 1, 2, 3, 4, 5, 6, 7, 8, 9, 10, 11, 12, 13, 8, 9, 10, 11, 12, 13, 14, 15, 16, 17, 18, 19, 20, 21, 22, 23, 24, 25, 26, 27, 28, 29, or 30 parts by weight. In an embodiment, the high softening point resin is present in an amount of about 0.5 parts by weight to about 25 parts by weight, and, in an embodiment, about 1 part by weight to about 20 parts by weight. When the content of the high softening point resin is 0.1 parts by weight or more, the adhesive composition can soften in a durability test. When the content of the high softening point resin is 30 parts by weight or less, the adhesive composition can prevent or substantially prevent deterioration in durability due to the low molecular weight of the high softening point resin. In addition, the adhesive composition can effectively prevent deterioration in flexibility at a low temperature of −25° C. or less, thereby securing durability under harsh conditions.

In an embodiment, the high softening point resin has a softening point of 60° C. to 200° C. In an embodiment, the high softening point resin has a softening point of 70° C. to 150° C. in terms of improvement in step-filling properties, processability, and adhesion. In an embodiment, the high softening point resin has a softening point of about 80° C. to about 140° C., and, in an embodiment, about 85° C. to about 130° C. Herein, the softening point is measured by a method described in JIS K6863 (1994).

### Other Additives

The adhesive composition for optical films according to the present invention may further include typical additives (other additives) known in the art, such as any of a photopolymerization initiator, a solvent, a crosslinking accelerator, an anti-aging agent, fillers, a colorant (pigments or dyes), a UV absorber, an antioxidant, a plasticizer, a softener, a surfactant, and an antistatic agent, without affecting the effects of the present invention.

The photopolymerization initiator may be used in formation of an adhesive layer. The photopolymerization initiator may include α-diketones, such as benzoin, diacetyl, and the like; benzophenone derivatives, such as benzophenone and the like; benzoic acid ester derivatives; acyloin ether derivatives; acetophenone derivatives, such as acetophenone and the like; xanthone and thioxanthone derivatives; halogen compounds including chlorosulfonyl, chloromethyl polynuclear aromatic compounds, chloromethyl heterocyclic compounds, chloromethyl benzophenones, and the like; triazines; fluorenones; haloalkanes; acridines; redox twins of a photoreducing dye and a reducing agent; organic sulfur compounds; peroxides, and the like.

In an embodiment, the photopolymerization initiator may include any of 1-hydroxyphenylketone, 2-methyl-1-(4-(methylthio)phenyl)-2-morpholinopropane-1-one, (2-benzyl-2-dimethyl amino-1-(4-morpholinophenyl)-butanon-1,1-hydroxy-cyclohexyl-phenyl-ketone, 2,2-dimethoxy-2-phenylacetophenone, 2-hydroxy-2-methyl-1-phenyl-propane-1-one, 2-benzyl-2-(dimethyl amino)-4-morpholinobutylphenone, 2-methyl-4′-(methylthio)-2-morpholino-propiophenone, 1,7-bis(9-acrydinyl)heptane, 2,2′-bis(o-chlorophenyl)-4,5,4′,5′-tetraphenyl-1,2′-biimidazol, 4,4′-dimethylaminobenzophenone, 4,4′-diethylaminobenzophenone, 7-(diethylamino)-4-methyl-2H-1-benzopyran-2-one, 7-(diethylamino)-4-methylcoumarin, 4-dimethylamino ethyl benzoate, 2-dimethylamino ethyl benzoate, 4-dimethylamino (n-butyxy) ethyl benzoate, p-dimethylamino benzoic acid isoamyl ethyl ester, 4-dimethylamino 2-ethylhexyl benzoate, 4,4′-diethylamino benzophenone, diphenyl (2,4,6-trimethylbenzoyl)phosphine oxide, and the like. Examples of commercially available photopolymerization initiators may include Omnirad® 907, 369, 184, 819, TPO (all available from IGM Resins B.V.), NISSOCURE MABP (available from Nippon Soda Co., Ltd.), EAB (available from Hodogaya Co., Ltd.), Kayacure® EPA, DMBI (available from Nippon Kayaku Co., Ltd.), Quantacure DMB, BEA (available from International Bio-Synthetics), Esolol 50 (Van Dyk), and the like. These may be used alone or in combination thereof.

In an embodiment, the photopolymerization initiator is present in an amount of about 0.01 parts by weight to about 1 part by weight, and, in an embodiment, about 0.05 parts by weight to about 0.5 parts by weight, relative to 100 parts by weight of the main component. Within this range of the photopolymerization initiator, the adhesive composition can exhibit good durability and adhesive strength.

The UV absorbent is present in an amount of about 0.010 parts by weight to about 5 parts by weight relative to 100 parts by weight of the main component. Within this range, the adhesive composition can prevent or substantially prevent excessive curing or can secure stable control of curing reaction in formation of an adhesive layer, thereby securing stable formation of the adhesive layer having sufficient step-filling properties. In an embodiment, the UV absorbent is present in an amount of about 0.010 parts by weight to about 3 parts by weight, and, in an embodiment, about 0.010 parts by weight to about 1 part by weight, and, in an embodiment, about 0.010 parts by weight to about 0.1 parts by weight, and, in an embodiment, about 0.05 parts by weight to about 0.1 parts by weight. Within this range, the adhesive composition allows stable formation of an adhesive layer having sufficient step-filling properties.

### Method of Preparing Adhesive Composition

The adhesive composition according to the present invention may be prepared by mixing the main component, the chain transfer agent, and other components, as needed. Here, the mixing procedure and mixing temperature of these components are not particularly limited and may be suitably adjusted by those skilled in the art.

<A Photocurable Adhesive Composition for Optical Films>

A photocurable adhesive composition for optical films according to another aspect of the present invention includes a syrup prepared through partial polymerization of a (meth)acrylic acid ester monomer composition, a UV absorbent, and a chain transfer agent. In addition, relative to 100 parts by weight of the syrup, the UV absorbent may be present in an amount of about 0.010 parts by weight to about 5 parts by weight and the chain transfer agent may be present in an amount of about 0.010 parts by weight to about 5 parts by weight.

The inventors of the present invention have conducted extensive studies in order to stably obtain an adhesive layer having sufficient step-filling properties. In this, it was found that a difference in cured state of an adhesive layer occurs even when the cumulative quantity of UV light irradiated upon manufacturing the adhesive layer is kept constant. This phenomenon was thought to be due to the fact that the quantity of UV light contributing to curing reaction differs for each coating film, causing difference in polymerization rate of monomers. It was found that this phenomenon occurred remarkably especially when the illuminance of UV light was increased. Therefore, although it was attempted to perform curing reaction at a relatively low illuminance, there was a problem in property stability and further improvement was required.

In this situation, as a result of further examination, the inventors of the present invention found that change in polymerization rate decreased even when the cumulative quantity of light was changed by an adhesive composition containing specific amounts of a UV absorbent and a chain transfer agent. When the UV absorbent or the chain transfer agent was used alone, the polarization rate was gently increased with increasing cumulative quantity of light. However, it was found that, when the specific amounts of the UV absorbent and the chain transfer agent were present in the adhesive composition, surprisingly, the change in polymerization rate was significantly reduced even with increase in cumulative quantity of light, thereby providing an adhesive layer having stable properties. The inventors completed the present invention based on these findings.

Details of the kind of chain transfer agent are the same as described above.

For example, relative to 100 parts by weight of the syrup, the chain transfer agent may be present in an amount of about 0.010, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, or 5 parts by weight. In an embodiment, the chain transfer agent may be present in an amount of about 0.010 parts by weight to about 3 parts by weight, and, in an embodiment, about 0.05 parts by weight to about 1 parts by weight, and, in an embodiment, about 0.05 parts by weight to about 0.1 parts by weight.

The UV absorbent is a substance that absorbs UV light and improves step-filling properties and property stability.

The UV absorbent may include, for example, benzotriazole UV absorbents, triazine UV absorbents, and the like. In an embodiment, benzotriazole UV absorbents or triazine UV absorbents are used in terms of property stability.

Examples of the benzotriazole UV absorbents may include 2-(2-hydroxy-5-tert-butylphenyl)-2H-benzotriazole, benzene propanoic acid 3-(2H-benzotriazole-2-yl)-5-(1,1-dimethylethyl)-4-hydroxy-C₇ to C₉-branched and linear alkyl ester, 2-[5-chloro-(2H)-benzotriazole-2-yl]-4-methyl-6-(tert-butyl)phenol, 2-(2H-benzotriazole-2-yl)-4,6-bis(1-methyl-1-phenylethyl)phenol, 2-(2H-benzotriazole-2-yl)-6-(1-methyl-1-phenylethyl)-4-(1,1,3,3-tetramethylbutyl)phenol, 2-(2-hydroxyphenyl)-benzotriazole derivatives, β-[3-(2H-benzotriazole-2-yl)-4-hydroxy-5-tert-butylphenyl]-propionic acid poly(ethylene glycol) 300-ester, bis{β-[3-(2H-benzotriazole-2-yl)-4-hydroxy-5-tert-butylphenyl]-propionic acid}-poly(ethylene glycol) 300-ester, and the like. Commercially available products of the benzotriazole UV absorbents may include Tinuvin® PS, 99-2, 326, 384-2, 900, 928, and 970 (BASF Japan Ltd.).

Examples of the triazine UV absorbents may include 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, 2,4-bis(2,4-dimethylphenyl)-6-[2-hydroxy-4-(3-alkyloxy-2-hydroxypropyloxy)-5-α-cumylphenyl]-s-triazine main backbone (long-chain alkyl group such as alkyloxy=octyloxy, nonyloxy, decyloxy, and the like)-containing UV absorbents, 2-(2-hydroxy-4-[1-octyloxycarbonylethoxy]phenyl)-4,6-bis(4-phenylphenyl)-1,3,5-triazine, and the like. Commercially available products of the triazine UV absorbents may include Tinuvin® 1130, 400, 405, 460, 477, and 479 (BASF Japan Ltd.).

These may be used alone or in combination thereof.

The UV absorbent is present in an amount of about 0.010 parts by weight to about 5 parts by weight, relative to 100 parts by weight of the syrup prepared through partial polymerization of the (meth)acrylic acid ester monomer composition. If the content of the UV absorbent is less than about 0.010 parts by weight, the adhesive composition can be too cured to achieve sufficient step-filling properties and does not allow stable control of curing reaction in formation of an adhesive layer, thereby making it difficult to achieve stable formation of the adhesive layer having sufficient step-filling properties. If the content of the UV absorbent exceeds about 5 parts by weight, the adhesive composition is not cured, thereby failing to form the adhesive layer. For example, the UV absorbent may be present in an amount of about 0.010, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, or 5 parts by weight. In an embodiment, the UV absorbent is present in an amount of about 0.010 parts by weight to about 3 parts by weight, and, in an embodiment, about 0.010 parts by weight to about 1 part by weight, and, in an embodiment, about 0.010 parts by weight to about 0.1 parts by weight, and, in an embodiment, about 0.05 parts by weight to about 0.1 parts by weight. Within this range, the adhesive composition can stably form an adhesive layer having sufficient step-filling properties.

Next, the syrup prepared through partial polymerization of the (meth)acrylic acid ester monomer composition will be described.

The syrup is prepared from the (meth)acrylic acid ester monomer composition including at least one of (a1): a linear or branched C₁ to C₁₄ alkyl group-containing (meth)acrylic acid ester monomer and (a2): a cyclic C₃ to C₁₄ alkyl group-containing (meth)acrylic acid ester monomer; and at least one of (a3): a hydroxyl group-containing (meth)acrylic acid ester monomer and (a4): an amide group-containing monomer.

The linear or branched C₁ to C₁₄ alkyl group-containing (meth)acrylic acid ester monomer (a1), the cyclic C₃ to C₁₄ alkyl group-containing (meth)acrylic acid ester monomer (a2), the hydroxyl group-containing (meth)acrylic acid ester monomer (a3), and the amide group-containing monomer (a4) are substantially the same as those described in the adhesive composition according to one aspect of the present invention.

In an embodiment, in the monomer composition, at least one of the linear or branched C₁ to C₁₄ alkyl group-containing (meth)acrylic acid ester monomer (a1) and the cyclic C₃ to C₁₄ alkyl group-containing (meth)acrylic acid ester monomer (a2) is present in an amount of about 10 parts by weight to about 80 parts by weight, for example, about 10, 15, 20, 25, 30, 35, 40, 45, 50, 55, 60, 65, 70, 75, or 80 parts by weight, and, in an embodiment, about 15 parts by weight to about 80 parts by weight, relative to 100 parts by weight of the monomer composition. When the corresponding content is about 10 parts by weight or more, it is possible to easily secure the step-filling properties. When the corresponding content is about 80 parts by weight or less, it is possible to easily secure property balance as an adhesive.

In an embodiment, in the monomer composition, at least one of the hydroxyl group-containing (meth)acrylic acid ester monomer (a3) and the amide group-containing monomer (a4) is present in an amount of about 10 parts by weight to about 50 parts by weight, for example, about 10, 15, 20, 25, 30, 35, 40, 45, or 50 parts by weight, and, in an embodiment, about 20 parts by weight to about 50 parts by weight, relative to 100 parts by weight of the monomer composition. When the corresponding content is about 10 parts by weight or more, it is possible to achieve balance between the step-filling properties and property stability. When the corresponding content is about 50 parts by weight or less, it is possible to secure durability.

In an embodiment, in the monomer composition, the hydroxyl group-containing (meth)acrylic acid ester monomer (a3) is present in an amount of about 5 parts by weight to about 40 parts by weight, for example, about 5, 10, 15, 20, 25, 30, 35, or 40 parts by weight, and, in an embodiment, about 10 parts by weight to about 35 parts by weight, relative to 100 parts by weight of the monomer composition, without being limited thereto. Within this range, the adhesive composition can secure moist heat durability or the step-filling properties.

In an embodiment, in the monomer composition, the amide group-containing monomer (a4) is present in an amount of about 5 parts by weight to about 35 parts by weight, for example, about 5, 10, 15, 20, 25, 30, or 35 parts by weight, and, in an embodiment, about 5 parts by weight to about 25 parts by weight, relative to 100 parts by weight of the monomer composition, without being limited thereto. Within this range, the adhesive composition can secure moist heat durability or the step-filling properties.

The monomer composition may further include an aromatic hydrocarbon group-containing (meth)acrylic acid ester monomer.

The aromatic hydrocarbon group-containing (meth)acrylic acid ester monomer is substantially the same as that described in the adhesive composition according to one aspect of the present invention.

In an embodiment, in the monomer composition, the aromatic hydrocarbon group-containing (meth)acrylic acid ester monomer is present in an amount of about 0 parts by weight to about 50 parts by weight, for example, about 0, 5, 10, 15, 20, 25, 30, 35, 40, 45, or 50 parts by weight, and, in an embodiment, about 10 parts by weight to about 40 parts by weight, relative to 100 parts by weight of the monomer composition, without being limited thereto. When the corresponding content is about 10 parts by weight or more, it is possible to achieve balance between the step-filling properties and property stability. When the corresponding content is about 50 parts by weight or less, it is possible to achieve balance between the step-filling properties and property stability.

Partial Polymer

A partial polymer of the (meth)acrylic acid ester monomer composition (herein referred to as “partial polymer”) is obtained through partial polymerization of the monomer composition. The partial polymer serves to impart viscosity to the adhesive composition.

Herein, partial polymerization refers to polymerization in which a reaction rate of a monomer (that is, yield of a polymer; conversion) is in the range of about 3 wt % to about 20 wt %. The reaction rate can be confirmed by drying the monomer component at 150° C. or higher for 20 minutes or more to evaporate the monomer component in order to obtain the residual amount of the polymer component, followed by determining the ratio of the residual amount of the polymer component to the weight of the polymer component before drying. Accordingly, the syrup may also refer to a mixture comprising about 80 wt % to about 97 wt % of a monomer composition-derived unreacted monomer and about 3 wt % to about 20 wt % of the partial polymer (total amount: 100 wt %). In an embodiment, in terms of viscosity of the adhesive composition, the partial polymer is present in an amount of about 3 wt % to about 20 wt %, and, in an embodiment, about 5 wt % to about 15 wt %, in the syrup.

The partial polymer may be obtained by partially polymerizing the monomer composition. Since the monomer composition used as the raw material has been described above, further detailed description thereof will be omitted. In addition, for partial polymerization, a photopolymerization initiator may be added, as needed.

According to the present invention, the monomer composition may be the same as or different from the monomer composition used as the raw material of the partial polymer. Here, it is desirable that the monomer composition be the same as the monomer composition used as the raw material of the partial polymer in order to secure good properties of an adhesive layer and a cured product thereof.

In an embodiment, the partial polymer has a glass transition temperature (Tg) of about −60° C. to less than about 20° C., for example, −60, −55, −50, −45, −40, −35, −30, −25, −20, −15, −10, −5, 0, 5, 10, 15, or 19° C., and, in an embodiment, about −40° C. to less than about 20° C., and, in an embodiment, about −20° C. to about 10° C., without being limited thereto. Within this range, the adhesive composition can improve adhesion between a cured product and an adherend after completely curing the adhesive layer, and can exhibit sufficient properties in a use temperature range.

In an embodiment, the partial polymer has a weight average molecular weight (Mw) of about 300,000 to about 3,000,000, and, in an embodiment, about 500,000 to about 2,000,000, in terms of balance between the step-filling properties and property stability, without being limited thereto. Herein, the weight average molecular weight (Mw) is measured by gel permeation chromatography.

The adhesive composition may further include a crosslinking agent, a photopolymerization initiator, a photo enhancing agent, a silane coupling agent, a high softening point resin, and other components described above. The crosslinking agent, the photopolymerization initiator, the silane coupling agent, the high softening point resin, and the other components are substantially the same as those of the adhesive composition according to one aspect of the present invention.

In an embodiment, the crosslinking agent is present in an amount of about 0.01 parts by weight to about 5 parts by weight, for example, about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, or 5 parts by weight, and, in an embodiment, about 0.03 parts by weight to about 3 parts by weight, relative to 100 parts by weight of the syrup. Within this range, the adhesive composition can secure balance between the step-filling properties and property stability.

In an embodiment, the photopolymerization initiator is present in an amount of about 0.01 parts by weight to about 1 part by weight, and, in an embodiment, about 0.05 parts by weight to about 0.5 parts by weight, relative to 100 parts by weight of the syrup. Within this range, the adhesive composition can secure balance between the step-filling properties and property stability.

### Photocurable Adhesive Layer for Optical Films

In accordance with another aspect of the present invention, a photocurable adhesive layer for optical films (herein, referred to as “adhesive layer”) is obtained by curing the photocurable adhesive composition for optical films. The adhesive layer is distinguished from the adhesive composition in that the reaction rate of the monomer exceeds 95 wt %. In addition, the adhesive layer is distinguished from a cured product of an adhesive layer described below in that the adhesive layer contains a certain amount or more of multifunctional compounds and has reactivity.

In an embodiment, the adhesive layer has a thickness of about 20 μm to about 1 mm, and, in an embodiment, about 30 μm to about 500 μm, and, in an embodiment, about 50 μm to about 300 μm. When the adhesive layer has a thickness of 20 μm or more, the adhesive layer can easily fill printing steps (in general, 1 μm to 100 μm). When the adhesive layer has a thickness of 1 mm or less, the adhesive layer can secure coatability and a uniform thickness.

In an embodiment, the adhesive layer has a weight average molecular weight of about 50,000 to about 1,000,000, for example, 50,000, 100,000, 150,000, 200,000, 250,000, 300,000, 350,000, 400,000, 450,000, 500,000, 550,000, 600,000, 650,000, 700,000, 750,000, 800,000, 850,000, 900,000, 950,000 or 1,000,000, and, in an embodiment, about 100,000 to about 800,000, and, in an embodiment, about 200,000 to about 750,000. When the weight average molecular weight of the adhesive layer is about 50,000 or more, the adhesive layer can secure improvement in durability. When the weight average molecular weight of the adhesive layer is about 1,000,000 or less, the adhesive layer can secure improvement in the step-filling properties. Herein, the weight average molecular weight may be measured by a method described in examples.

### Method of Forming Adhesive Layer

In accordance with a further aspect of the present invention, a method of forming a photocurable adhesive layer for optical films includes: coating the photocurable adhesive composition for optical films on a surface of a first release sheet subjected to release treatment to form a coating layer, stacking a second release sheet on the coating layer such that a surface of the second release sheet subjected to release treatment adjoins a surface of the coating layer, and irradiating the coating layer with actinic energy through at least one of the first release sheet and the second release sheet.

The adhesive composition may be directly coated onto an optical film to form the adhesive layer. In an embodiment, the adhesive layer is formed by coating the adhesive composition onto the surface of the first release sheet subjected to release treatment (also referred to as “release film” or “separator”) to form the coating layer, stacking the second release sheet on the coating layer such that the surface of the second release sheet subjected to release treatment adjoins the surface of the coating layer, and irradiating the coating layer through at least one of the first release sheet and the second release sheet with actinic energy to cure the adhesive composition. Then, in an embodiment, the adhesive layer is transferred to any of various optical films.

Here, the release sheets with the adhesive layer attached thereto may be wound into a roll in the forming process. Then, when the adhesive layer is bonded to various optical films or liquid crystal panels, the release sheets wound into a roll shape may be cut or processed to be attached to any of various optical films or liquid crystal panels, as desired, followed by removal of the release sheets. In addition, the release sheets also serve to protect the adhesive layer until the adhesive layer is put into use.

The release sheets may be formed of, for example, plastic films, such as polyethylene, polypropylene, polyethylene terephthalate and polyester films, porous materials, such as paper, cloth and nonwoven fabrics, and thin laminate materials, such as nets, foamed sheets, metal foils, and laminates thereof. In an embodiment, plastic films are used in terms of good surface smoothness.

The release sheets may have a thickness of about 5 μm to about 200 μm, and, in an embodiment, about 5 μm to about 100 μm.

The release sheets may be subjected to release treatment with a silicone, fluorine, long-chain alkyl or fatty acid amide release agent or silica powder.

The adhesive composition for optical films according to the present invention may be coated onto the release sheet subjected to release treatment by any typical method known in the art. Examples of the coating method may include extrusion coating, such as roll coating, kiss roll coating, gravure coating, reverse coating, roll brush coating, spray coating, dip roll coating, bar coating, knife coating, air knife coating, curtain coating, lip coating, die coating, and the like.

The coating layer formed on the release sheet may be irradiated with the actinic energy. The actinic energy may be emitted only through the first release sheet, only through the second release sheet, or through both the first release sheet and the second release sheet (that is, at both sides of the coating layer).

Examples of the actinic energy may include UV light, laser beams, α-rays, β-rays, γ-rays, X-rays, and electron beams. In an embodiment, UV light, and, in an embodiment, UV light having a wavelength of about 200 nm to about 400 nm, is used as the actinic energy in terms of controllability, handling properties and costs. UV light is irradiated using a light source, such as a high-pressure mercury lamp, a microwave excitation lamp, a chemical lamp, and black lights. Although only one side of the coating layer may be irradiated with UV light, it is desirable that both sides of the coating layer be irradiated with UV light to form an adhesive layer having more stable performance.

Although the irradiance of the actinic energy (e.g., UV light) is not particularly limited, in an embodiment, the adhesive layer is formed through irradiation with UV light having a lower irradiance than a typical case. In an embodiment, the actinic energy has an irradiance of about 0.5 mW/cm² to about 50 mW/cm², and, in an embodiment, about 1.0 mW/cm² to about 30 mW/cm². When the irradiance of the actinic energy is 0.5 mW/cm² or more, curing reaction can be efficiently carried out. When the irradiance of the actinic energy is 50 mW/cm² or less, the adhesive layer having sufficient step-filling properties can be stably formed.

Although the cumulative quantity of the actinic energy (e.g., UV light) is not particularly limited in formation of the adhesive layer, in an embodiment, the cumulative quantity of the actinic energy is in the range of about 300 mJ/cm² to about 2,000 mJ/cm², and, in an embodiment, about 500 mJ/cm² to about 1,000 mJ/cm². Within this range of the cumulative quantity, the effects of the present invention can be efficiently obtained.

### Optical Member

The adhesive layer is completely cured through irradiation with the actinic energy, with the adhesive layer attached to an optical film. As a result, an optical member having a first optical film on one surface of a cured product of the adhesive layer may be formed. In other words, in accordance with yet another embodiment of the present invention, an optical member including the cured product of the adhesive layer and the first optical film formed on one surface of the cured product is provided. In an embodiment, the optical member further includes a glass sheet, a poly(methyl methacrylate) sheet, a polycarbonate sheet, or a second optical film on a surface of the cured product of the adhesive layer opposite to the surface of the cured product having the first optical film formed thereon.

### Bonding Facilitation-Treated Layer (Bonding Facilitation Layer)

In an embodiment, the optical member further includes at least one bonding facilitation layer between the first optical film and the cured product of the adhesive layer.

In an embodiment, the optical member includes a first bonding facilitation layer and a second bonding facilitation layer. In the optical member, the first optical film, the first bonding facilitation layer, the second bonding facilitation layer, and the cured product of the adhesive layer for optical films are sequentially stacked. When the optical member includes both the first bonding facilitation layer and the second bonding facilitation layer, the optical film is more securely bonded to the cured product of the adhesive layer. Here, the configuration (material, etc.) of the first bonding facilitation layer may be the same as or different from that of the second bonding facilitation layer.

The bonding facilitation layers may be formed by a process in which a surface of a member to be attached to the adhesive layer is subjected to corona treatment, plasma treatment, or the like. In an embodiment, the bonding facilitation layers may be formed by forming a separate member, such as a primer layer, on the surface of the optical member to be attached to the adhesive layer.

In an embodiment, the primer layer is formed of a material having good adhesion to the optical member and capable of forming a highly cohesive film. For example, the material may include various polymers, sols of metal oxides, and silica sol. In an embodiment, the material may include any of various polymers. The primer layer may also have antistatic properties

Examples of the polymers used to form the primer layer may include an oxazoline group-containing polymer, a polyurethane resin, a polyester resin, and an amino group-containing polymer. In an embodiment, the oxazoline group-containing polymer is used.

The oxazoline group-containing polymer may include any suitable commercially available product. Examples of the commercially available products may include EPOCROS® series (for example, EPOCROS® WS700) (Nippon Shokubai Co., Ltd.), without being limited thereto. Examples of the polyurethane resin, the polyester resin, and the amino group-containing polymer are disclosed in paragraphs 0107 to 0114 of Japanese Unexamined Patent Publication No. 2011-105918.

In an embodiment, the primer layer has a thickness of 10 nm to 5,000 nm, and, in an embodiment, 50 nm to 500 nm. Within this range, the primer layer can exhibit sufficient strength and adhesion without deterioration in optical properties.

For example, the primer layer may be formed by coating a material for the primer layer (undercoating material) through dip coating, spray coating or the like, followed by drying.

### Method of Manufacturing Optical Member

The optical member may be manufactured by irradiating the adhesive layer with actinic energy, with an optical film disposed on one surface of the adhesive layer, so as to completely cure the adhesive layer.

In other words, in accordance with yet another embodiment of the present invention, a method of manufacturing an optical member includes placing an optical film on one surface of the adhesive layer and irradiating the adhesive layer with actinic energy at a cumulative quantity of about 300 mJ/cm² to about 5,000 mJ/cm². In a structure wherein a cover glass or cover plastic film or a second optical film is disposed on the other surface of the adhesive layer, with the optical film placed on one surface of the adhesive layer, the cover glass or cover plastic film or the second optical film may be placed on the other surface of the optical film, followed by irradiating the adhesive layer with actinic energy at a cumulative quantity of about 300 mJ/cm² to about 5,000 mJ/cm².

As in formation of the adhesive layer, for example, UV light, laser beams, α-rays, β-rays, γ-rays, X-rays, and electron beams may be used as the actinic energy. In an embodiment, UV light, and, in an embodiment, UV light having a wavelength of about 200 nm to about 400 nm, is used as the actinic energy in terms of controllability, handling properties and costs. UV light is irradiated using a light source, such as a high-pressure mercury lamp, a microwave excitation lamp, a chemical lamp, and black lights. Although only one side of the coating layer may be irradiated with UV light, it is desirable that both sides of the coating layer be irradiated with UV light to form an adhesive layer having more stable performance.

Although the irradiance of the actinic energy (e.g., UV light) is not particularly limited, in an embodiment, the actinic energy is emitted at an irradiance of about 50 mW/cm² to about 500 mW/cm², and, in an embodiment, about 80 mW/cm² to about 300 mW/cm². When the irradiance of the actinic energy is 50 mW/cm² or more, curing time can be reduced. When the irradiance of the actinic energy is 500 mW/cm² or less, it is possible to secure the step-filling properties.

Although the cumulative quantity of the actinic energy (e.g., UV light) is not particularly limited, in an embodiment, the actinic energy is emitted at a cumulative quantity of about 500 mJ/cm² to about 5,000 mJ/cm², and, in an embodiment, about 1,000 mJ/cm² to about 3,000 mJ/cm². Within this range of the cumulative quantity, it is possible to manufacture an optical member having sufficient durability.

Display Apparatus

In accordance with yet another aspect of the present invention, a display apparatus including the optical member is provided.

The display apparatus may include, for example, any of liquid crystal displays, organic EL displays, plasma display panels (PDPs), and micro LED display panels, without being limited thereto.

### EXAMPLES

Next, the present invention will be described in more detail with reference to some examples. However, it should be noted that these examples are provided for illustration only and should not be construed in any way as limiting the invention. Unless otherwise stated, “parts” refers to “parts by weight” in the following description. In addition, unless otherwise stated, the following manipulation and measurement of properties were carried out at 23° C. and 55% RH.

### Measurement of Properties

(Glass Transition Temperature (Tg))

The glass transition temperature (Tg) of the copolymer (a) was calculated by the Fox equation based on the glass transition temperature of a homopolymer of each of the monomers.

The weight average molecular weights (Mw) of the (meth)acrylic acid ester copolymer (a) and the adhesive layer were measured by GPC (gel permeation chromatography). The weight average molecular weight of the adhesive layer was measured for soluble components by the same method after dissolution in tetrahydrofuran (THF).

Analytical Apparatus: HLC-8120GPC (Tosoh Corporation)

Column: G7000HXL+GMHXL+GMHXL (Tosoh Corporation)

Column size: each 7.8 mmφ×30 cm, 90 cm in total

Column temperature: 40° C.

Flow rate: 0.8 ml/min

Injection volume: 100 μl

Eluent: Tetrahydrofuran

Detector: Differential refractometer (RI)

Standard sample: Polystyrene

### Manufacture of Thin Polarizing Plate

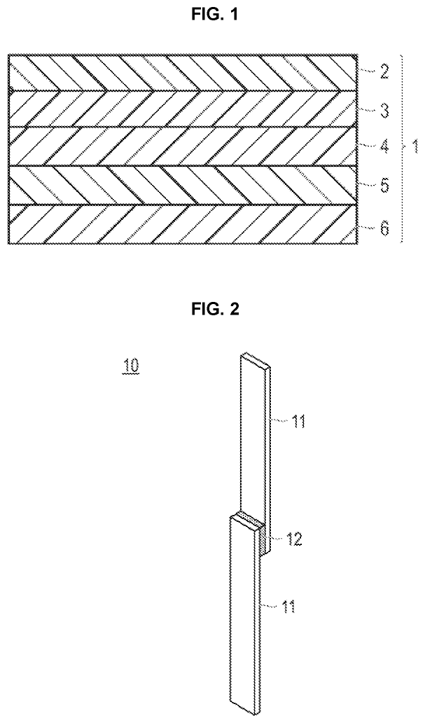

A method of manufacturing a thin polarizing plate will be described with reference to FIG. 1.

A 20 μm thick polyvinyl alcohol film was stretched to 3 times an initial length thereof between rolls having different speeds in a 0.3 wt % iodine solution for dyeing at 30° C. for 1 minute. Then, the dyed film was dipped in an aqueous solution of 4 wt % boric acid and 10 wt % potassium iodide at 60° C. for 0.5 minutes while being stretched to 6 times the initial length thereof. Then, the resulting film was dipped in an aqueous solution of 1.5 wt % potassium iodide at 30° C. for 10 seconds to be cleaned, followed by drying at 50° C. for 4 minutes, thereby obtaining a 7 μm thick polarizer 4.

A 20 μm thick polycarbonate film 2 and a 50 μm thick retardation film 6 (λ/4 plate, WRS, Taijin Co., Ltd.) were bonded to opposite sides of the polarizer 4 via polyvinyl alcohol adhesives 3, 5, respectively, thereby preparing a thin polarizing plate 1 having a total thickness of 77 μm.

Details of components used in Preparative Examples 1 to 23 are as follows.

2EHA: 2-ethylhexyl acrylate (homopolymer Tg: −68° C., Nippon Shokubai Co., Ltd.)

IBXA: isobornyl acrylate (homopolymer Tg: 97° C., Osaka Organic Chemical Industry Co., Ltd.)

CHA: cyclohexyl acrylate (homopolymer Tg: 15° C., Osaka Organic Chemical Industry Co., Ltd.)

4HBA: 4-hydroxybutyl acrylate (homopolymer Tg: −32° C., Osaka Organic Chemical Industry Co., Ltd.)

ACMO®: acryloylmorpholine (homopolymer Tg: 145° C., KJ Chemical Co., Ltd.)

BzA: benzyl acrylate (homopolymer Tg: 9° C., Hitachi Chemical Industry Co., Ltd.)

i-StA: isostearyl acrylate (homopolymer Tg: −18° C., Osaka Organic Chemical Industry Co., Ltd.)

DTD-A: 2-decyltetradecaneyl acrylate (homopolymer Tg: −36° C., Kyoeisha Chemical Co., Ltd.)

EHDG-AT: 2-ethylhexyl-di glycol acrylate (LIGHT ACRYLATE) EHDG-AT, homopolymer Tg: −70° C., Kyoeisha Chemical Co., Ltd.)

BA: acrylate (homopolymer Tg: −45° C., Nippon Shokubai Co., Ltd.)

### Preparation of Acryl Syrup AS-1

### Preparative Example 1

In a reaction box configured to block external UV light, four UV lamps (Black light FL20SBL, Sankyo-Denki Co., Ltd.) were disposed in each of four directions. A 2 L four-necked flask equipped with a stirring blade, a thermometer, a nitrogen gas inlet tube and a cooler was placed in the reaction box. 35 parts of 2-ethylhexyl acrylate, 15 parts of isobornyl acrylate, 25 parts of 4-hydroxybutyl acrylate, and 25 parts of acryloylmorpholine were introduced into the flask and heated to 30° C. while purging with nitrogen gas.

Then, 0.005 parts of 2,2-dimethoxy-1,2-diphenylethane-1-one (Omnirad® 651, IGM Resins B.V.) was introduced as a photopolymerization initiator into the flask while stirring, followed by uniformly mixing the components.

For initiation of polymerization, the mixture was irradiated with UV light using the black light (cumulative light quantity: 200 mJ/cm²). After initiation of reaction, the reaction was stopped by introducing air into the flask using an air pump when the reaction temperature was increased by 10° C., thereby preparing an acryl syrup AS-1. In 100 g of the acryl syrup AS-1, a (meth)acrylic acid ester copolymer A-1 was present in an amount of 10.5 g and an unreacted monomer was present in an amount of 89.5 g. The glass transition temperature (Tg) and the weight average molecular weight (Mw) of the (meth)acrylic acid ester copolymer A-1 contained in in the acryl syrup AS-1 are shown in Table 1.

### Preparative Examples 2 to 19

Acryl syrups AS-2 to AS-19 were prepared in the same manner as in Preparative Example 1 except that the kinds and contents of monomers and the content of the photopolymerization initiator were changed as listed in Table 1. In 100 g of each of the acryl syrups AS-2 to AS-19, each of (meth)acrylic acid ester copolymers A-2 to A-19 was present in an amount of 10.5 g and an unreacted monomer was present in an amount of 89.5 g. The glass transition temperature (Tg) and the weight average molecular weight (Mw) of each of the (meth)acrylic acid ester copolymers A-2 to A-19 contained in the acryl syrups AS-2 to AS-19 are shown in Table 1.

TABLE 1

| | | | | | | | | | | | Photopolymerization | | |
|---|---|---|---|---|---|---|---|---|---|---|---|---|---|
| | | | | | | | | | | | initiator | | |
| | Acryl | Monomer (parts) | | | | | | | | | (parts) | | |
| | syrup | (a1) | (a2) | | (a3) | (a4) | (a5) | | | | Ominrad ^{®} | Tg | Mw |
| | AS-1 | 2EHA | IBXA | CHA | 4HBA | ACMO | BzA | i-StA | DTD-A | EHDG-AT | 651 | (° C.) | (*10⁴) |
| Preparative | A-1 | 35 | 15 | | 25 | 25 | | | | | 0.005 | −6.2 | 175 |
| Example 1 | | | | | | | | | | | | | |
| Preparative | A-2 | 25 | 30 | | 30 | 15 | | | | | 0.005 | 2.2 | 175 |
| Example 2 | | | | | | | | | | | | | |
| Preparative | A-3 | 35 | | 15 | 25 | 25 | | | | | 0.005 | −14.2 | 175 |
| Example 3 | | | | | | | | | | | | | |
| Preparative | A-4 | 35 | 25 | | 20 | 20 | 20 | | | | 0.005 | −0.3 | 175 |
| Example 4 | | | | | | | | | | | | | |
| Preparative | A-5 | 35 | 25 | | 20 | 20 | | 15 | | | 0.005 | −4.3 | 160 |
| Example 5 | | | | | | | | | | | | | |
| Preparative | A-6 | 35 | 25 | | 20 | 20 | | | 15 | | 0.005 | −7.0 | 165 |
| Example 6 | | | | | | | | | | | | | |
| Preparative | A-7 | 35 | 25 | | 20 | 20 | | | | 10 | 0.005 | −10.1 | 160 |
| Example 7 | | | | | | | | | | | | | |
| Preparative | A-8 | 20 | 50 | | 15 | 15 | 15 | | | 10 | 0.005 | 15.5 | 160 |
| Example 8 | | | | | | | | | | | | | |
| Preparative | A-9 | 30 | | 30 | 20 | 20 | 10 | | | | 0.005 | −9.1 | 170 |
| Example 9 | | | | | | | | | | | | | |
| Preparative | A-9 | 30 | 20 | | 25 | 25 | | | | | 0.005 | 1.8 | 170 |
| Example 10 | | | | | | | | | | | | | |
| Preparative | A-11 | 45 | 45 | | 5 | 5 | 30 | | | | 0.005 | −2.3 | 160 |
| Example 11 | | | | | | | | | | | | | |
| Preparative | A-12 | 40 | 30 | | 20 | 10 | 20 | | | | 0.05 | −8.7 | 140 |
| Example 12 | | | | | | | | | | | | | |
| Preparative | A-13 | 40 | 30 | | 20 | 10 | 20 | | | | 0.001 | −8.7 | 220 |
| Example 13 | | | | | | | | | | | | | |
| Preparative | A-14 | 80 | | | 20 | | | | | | 0.005 | −61.7 | 170 |
| Example 14 | | | | | | | | | | | | | |
| Preparative | A-15 | 50 | 40 | | 10 | | | | | | 0.005 | −18.9 | 170 |
| Example 15 | | | | | | | | | | | | | |
| Preparative | A-16 | 50 | 30 | | 10 | 10 | | | | | 0.005 | −16.8 | 170 |
| Example 16 | | | | | | | | | | | | | |
| Preparative | A-17 | 50 | 30 | | 20 | | | | | | 0.005 | −27.9 | 170 |
| Example 17 | | | | | | | | | | | | | |
| Preparative | A-18 | 40 | 40 | | 20 | | | | | | 0.005 | −14.1 | 170 |
| Example 18 | | | | | | | | | | | | | |
| Preparative | A-19 | 96 | | | 2 | 2 | | | | | 0.005 | −65.3 | 170 |
| Example 19 | | | | | | | | | | | | | |

Details of components used in Examples 1 to 47 and Comparative Examples 1 to 19 were as follows.

A-DPH: dipentaerythritol hexaacrylate (Shin Nakamura Chemical Industry Co., Ltd.)

EHMP: 2-ethylhexyl-3-mercaptopropionate (EHMP; SC Organic Chemistry Co., Ltd.)

EDMA: ethylene glycol dimethacrylate (Mitsui Kagaku Co., Ltd.)

DCP-A: dimethylol tricyclodecane diacrylate (LIGHT ACRYLATE) DCP-A, Kyoeisha Chemical Co., Ltd.)

TMP-A: trimethylol propane triacrylate (Light acrylate TMP-A, Kyoeisha Chemical Co., Ltd.)

DAP: diallyl phthalate (Osaka Soda Co., Ltd.)

TAIC: triallylisocyanurate (Mitsui Kagaku Co., Ltd.)

D-110N: adduct of xylylene diisocyanate (XDI) and trimethylol propane (TAKENATE® D-110N, Mitsui Kagaku Co., Ltd.)

A201H: polyhexamethylene diisocyanate (DURANATE® A201H, Asahi Chemical Co., Ltd.)

TCP: bis(4-t-butylcyclohexyl) peroxydicarbonate (Peroyl® TCP, NOF Corporation)

KBE-403: 3-glycidoxypropyltrimethoxysilane (Shin-Etsu Kagaku Kogyo Co., Ltd.)

KE-100: Pinecrystal KE-100 (rosin ester resin, Arakawa Kagaku Kogyo Co., Ltd.)

TPO: diphenyl(2,4,6-trimethylbenzoyl)phosphine oxide (Omnirad® TPO, IGM Resins B.V.)

Tin479: hydroxyphenyltriazole UV absorbent (BASF Japan Ltd.)

Tin384-2: benzotriazole UV absorbent (BASF Japan Ltd.)

NOMP: n-octyl-3-mercaptopropionate (SC Organic Chemistry Co., Ltd.)

### Preparation of Adhesive Composition, Adhesive Layer, and Adhesive Layer-Attached Polarizing Plate

### Example 1

Relative to 100 parts by weight of the acryl syrup AS-1 ((meth)acrylic acid ester copolymer: 10.5 g, unreacted monomer: 89.5 g) prepared in Preparative Example 1, 0.05 parts of a crosslinking agent (dipentaerythritol hexaacrylate, A-DPH, Shin Nakamura Chemical Industry Co., Ltd.), 0.1 parts of a chain transfer agent (2-ethylhexyl-3-mercaptopropionate, EHMP, SC Organic Chemistry Co., Ltd.), and 0.1 parts of a photopolymerization initiator (1-hydroxycyclohexyl-phenyl ketone, Omnirad® 184, IGM Resins B.V.) were added to the acryl syrup, followed by mixing and degassing, thereby preparing an adhesive composition.

The adhesive composition was deposited to a thickness of 150 μm on one surface of a 75 μm thick polyethylene terephthalate (PET) film subjected to release (silicone) treatment. A 75 μm thick polyethylene terephthalate (PET) film having one surface subjected to release (silicone) treatment was bonded to the adhesive composition deposited on the surface of the PET film to have a sandwich structure in which the adhesive composition was interposed between the surfaces of the PET films subjected to release treatment. The adhesive composition was irradiated with UV light at an irradiance of 2.0 mW/cm² at upper and lower sides thereof (cumulative light quantity: 400 mJ/cm² at each of upper and lower sides of the sandwich structure) to form an adhesive layer.

Next, the PET film was removed from one side of the sandwich structure to expose the adhesive layer, which in turn was attached to the thin polarizing plate, thereby providing an adhesive layer-attached polarizing plate.

### Examples 2 to 28 and Comparative Examples 1 to 9

Adhesive compositions, adhesive layers and adhesive layer-attached polarizing plates were prepared in the same manner as in Example 1 except that the kind of acryl syrup, the kinds of additives, and the contents thereof were changed as listed in Tables 2-1 and 2-2.

The compositions of the adhesive compositions are shown in Tables 2-1 to 2-2.

TABLE 2-1

| | | | | | | | | Silane | | High | | | |
|---|---|---|---|---|---|---|---|---|---|---|---|---|---|
| | | | | | | | | coupling | | softening | | | |
| | Acryl | Chain transfer | | Crosslinking | | Crosslinking | | agent | | point resin | | Polymerization | |
| | syrup | agent | | agent | | agent | | (D) | | (E) | | initiator | |
| | (as-1) | | Content | | Content | | Content | | Content | | Content | | Content |
| | Kind | Kind | (parts) | Kind | (parts) | Kind | (parts) | Kind | (parts) | Kind | (parts) | Kind | (parts) |
| Example 1 | A-1 | EHMP | 0.1 | A-DPH | 0.05 | | | | | | | Omnirad184 | 0.1 |
| Example 2 | A-2 | EHMP | 0.1 | A-DPH | 0.05 | | | | | | | Omnirad184 | 0.1 |
| Example 3 | A-3 | EHMP | 0.1 | A-DPH | 0.05 | | | | | | | Omnirad184 | 0.1 |
| Example 4 | A-4 | EHMP | 0.1 | A-DPH | 0.05 | | | | | | | Omnirad184 | 0.1 |
| Example 5 | A-4 | EHMP | 0.1 | A-DPH | 0.05 | | | | | | | TPO | 0.1 |
| Example 6 | A-4 | EHMP | 0.02 | A-DPH | 0.05 | | | | | | | Omnirad184 | 0.1 |
| Example 7 | A-4 | EHMP | 0.5 | A-DPH | 0.05 | | | | | | | Omnirad184 | 0.1 |
| Example 8 | A-4 | EHMP | 1.0 | A-DPH | 0.05 | | | | | | | Omnirad184 | 0.1 |
| Example 9 | A-4 | EHMP | 4.0 | A-DPH | 0.05 | | | | | | | Omnirad184 | 0.1 |
| Example 10 | A-4 | EHMP | 0.1 | EDMA | 0.05 | | | | | | | Omnirad184 | 0.1 |
| Example 11 | A-4 | EHMP | 0.1 | DCP-A | 0.05 | | | | | | | Omnirad184 | 0.1 |
| Example 12 | A-4 | EHMP | 0.1 | TMP-A | 0.05 | | | | | | | Omnirad184 | 0.1 |
| Example 13 | A-4 | EHMP | 0.1 | DAP | 0.1 | | | | | | | Omnirad184 | 0.1 |
| Example 14 | A-4 | EHMP | 0.1 | TAIC | 0.1 | | | | | | | Omnirad184 | 0.1 |
| Example 15 | A-4 | EHMP | 0.1 | A-DPH | 0.05 | | | KBE-403 | 0.1 | | | Omnirad184 | 0.1 |
| Example 16 | A-4 | EHMP | 0.1 | A-DPH | 0.05 | D-110N | 0.1 | | | | | Omnirad184 | 0.1 |
| Example 17 | A-4 | EHMP | 0.1 | A-DPH | 0.05 | A201H | 0.5 | | | | | Omnirad184 | 0.1 |
| Example 18 | A-4 | EHMP | 0.1 | A-DPH | 0.05 | TCP | 0.5 | | | | | Omnirad184 | 0.1 |
| Example 19 | A-4 | EHMP | 0.1 | A-DPH | 0.05 | | | | | KE-100 | 10 | Omnirad184 | 0.1 |
| Example 20 | A-5 | EHMP | 0.1 | A-DPH | 0.05 | | | | | | | Omnirad184 | 0.1 |
| Example 21 | A-6 | EHMP | 0.1 | A-DPH | 0.05 | | | | | | | Omnirad184 | 0.1 |
| Example 22 | A-7 | EHMP | 0.1 | A-DPH | 0.05 | | | | | | | Omnirad184 | 0.1 |
| Example 23 | A-8 | EHMP | 0.1 | A-DPH | 0.05 | | | | | | | Omnirad184 | 0.1 |
| Example 24 | A-9 | EHMP | 0.1 | A-DPH | 0.05 | | | | | | | Omnirad184 | 0.1 |
| Example 25 | A-10 | EHMP | 0.1 | A-DPH | 0.05 | | | | | | | Omnirad184 | 0.1 |
| Example 26 | A-11 | EHMP | 0.1 | A-DPH | 0.05 | | | | | | | Omnirad184 | 0.1 |
| Example 27 | A-12 | EHMP | 0.1 | A-DPH | 0.05 | | | | | | | Omnirad184 | 0.1 |
| Example 28 | A-13 | EHMP | 0.1 | A-DPH | 0.05 | | | | | | | Omnirad184 | 0.1 |

TABLE 2-2

| | | | | | | | | Silane | | High | | | |
|---|---|---|---|---|---|---|---|---|---|---|---|---|---|
| | Acryl | Chain transfer | | Crosslinking | | Crosslinking | | coupling | | softening | | Polymerization | |
| | syrup | agent | | agent | | agent | | agent | | point resin | | initiator | |
| | AS-1 | | Content | | Content | | Content | | Content | | Content | | Content |
| | Kind | Kind | (parts) | Kind | (parts) | Kind | (parts) | Kind | (parts) | Kind | (parts) | Kind | (parts) |
| Comparative | A-14 | EHMP | 0.1 | A-DPH | 0.05 | | | | | | | Omnirad184 | 0.1 |
| Example 1 | | | | | | | | | | | | | |
| Comparative | A-15 | EHMP | 0.1 | A-DPH | 0.05 | | | | | | | Omnirad184 | 0.1 |
| Example 2 | | | | | | | | | | | | | |
| Comparative | A-16 | EHMP | 0.1 | A-DPH | 0.05 | | | | | | | Omnirad184 | 0.1 |
| Example 3 | | | | | | | | | | | | | |
| Comparative | A-17 | EHMP | 0.1 | A-DPH | 0.05 | | | | | | | Omnirad184 | 0.1 |
| Example 4 | | | | | | | | | | | | | |
| Comparative | A-18 | EHMP | 0.1 | A-DPH | 0.05 | | | | | | | Omnirad184 | 0.1 |
| Example 5 | | | | | | | | | | | | | |
| Comparative | A-19 | EHMP | 0.1 | A-DPH | 0.05 | | | | | | | Omnirad184 | 0.1 |
| Example 6 | | | | | | | | | | | | | |
| Comparative | A-4 | — | — | A-DPH | 0.05 | | | | | | | Omnirad184 | 0.1 |
| Example 7 | | | | | | | | | | | | | |
| Comparative | A-4 | EHMP | 0.001 | A-DPH | 0.05 | | | | | | | Omnirad184 | 0.1 |
| Example 8 | | | | | | | | | | | | | |
| Comparative | A-4 | EHMP | 6.0 | A-DPH | 0.05 | | | | | | | Omnirad184 | 0.1 |
| Example 9 | | | | | | | | | | | | | |

### Evaluation of Adhesive Layer

### Step-Filling Properties

The PET film was removed from the other side of each of the adhesive layer-attached polarizing plates manufactured in the Examples and Comparative Examples to expose the adhesive layer. Then, the adhesive layer was attached to a 0.5 mm thick polycarbonate plate (laminate roll temperature: 25° C. or 60° C.), which has a 50 μm thick printed step. Next, the adhesive layer was autoclaved at 50° C. under a pressure of 0.5 MPa for 15 minutes and completely pressed against a polycarbonate plate. Then, the adhesive layer was irradiated with UV light (UVA, irradiance: 100 mW/cm², cumulative light quantity: 2000 mJ/cm²) using a metal halide lamp at the polycarbonate plate side. An external appearance of the polarizing plate was evaluated with the naked eye and generation of bubbles in the gap between the printed step and a cured product of the adhesive layer was evaluated according to the following standards.

⊚: No bubbles at an end portion (edge portion)

◯: No problem in use despite slight generation of bubbles at an end portion (edge portion)

Δ: Unless used specifically, no problem in use despite slight generation of bubbles at an end portion (edge portion)

x: Many problems in use due to severe generation of bubbles at an end portion (edge portion)

### Durability

Samples for evaluation of durability were prepared in the same manner as in preparation of the samples for evaluation of step-filling properties. For the prepared samples, the following test was carried out and appearance of the sample was evaluated with the naked eye.

(1) Treatment at 85° C. for 500 hours (heating test)

(2) Treatment at 60° C./95% RH for 500 hours (humidification test)

(3) Treatment for 300 cycles (300 hours), in which each cycle refers to a process of allowing the sample to stand at 85° C. for 30 minutes and at −40° C. for 30 minutes (heat shock (HS) test)

Visual Evaluation

⊚: No bubbles at an end portion (edge portion)

◯: No problem in use despite slight generation of bubbles at an end portion (edge portion)

Δ: Unless used specifically, no problem in use despite slight generation of bubbles at an end portion (edge portion)

x: Many problems in use due to severe generation of bubbles at an end portion (edge portion)

Haze after being Left Under Moist Heat Conditions

The PET film was removed from one side of each of the adhesive layer-attached polarizing plates manufactured in the Examples and Comparative Examples to expose the adhesive layer, which in turn was pressed against an alkali-free glass plate (82 mm×53 mm×0.5 mm thick) using a roll. Then, the PET film was removed from the other side of the adhesive layer, which in turn was bonded to an alkali-free glass plate (82 mm×53 mm×0.5 mm thick) using a roll. Then, the adhesive layer was autoclaved (90° C., gauge pressure: 0.2 MPa, 20 minutes) and irradiated with UV light having a wavelength of 365 nm at an cumulative quantity: 2,000 mJ/cm² for curing, thereby preparing a sample for haze evaluation

The sample was left at 65° C. and 90% RH for 100 hours and then left at 23° C. and 50% RH for 2 hours, followed by measurement of haze using a hazemeter (NDH5000, Nippon Denshoku Industry Co., Ltd.) in accordance with JIS K7136 (2000). In an embodiment, a haze value is about 0.5%.

### Processing Suitability

With the PET films stacked on each of the adhesive layer-attached polarizing plates manufactured in the Examples and Comparative Examples, each of the polarizing plates was cut into 100 pieces using a Thompson cutter for curve and hole machining PET and the shape of an end portion (edge portion) thereof was observed. For each of the polarizing plates, the number of pieces which suffered from agglomeration at an end portion (edge portion), adhesive leakage, and PET film lifting was counted and evaluated according to the following criteria. ⊚ to ◯ denote good results.

—Evaluation Criteria—

⊚: 0 to 9 pieces

◯: 10 to 20 pieces

x: 21 pieces or more

(Relative Permittivity)

Each of the adhesive compositions prepared in the Examples and Comparative Examples was placed between a 125 μm thick polyethylene terephthalate (PET) film and a 50 μm thick release PET film and was pressed to a total thickness of 150 μm at 100° C. using a hot press to prepare a specimen, followed by measurement of relative permittivity of the adhesive layer at a frequency of 100 kHz and 25° C.

With an impedance analyzer 4294A (Agilent Inc.) connected to an impedance analyzer 1451B (Agilent Inc.), capacitance C_{B} of a specimen was measured at a frequency of 100 kHz. Capacitance C_{C} of the 125 μm thick PET and capacitance C_{D} of the 50 μm thick release PET film were measured, and capacitance C_{A} of the specimen was calculated according to the following Equation (i).

(1/C_{B})=(1/C_{A})+(1/C_{C})+(1/C_{D}) (i)

Relative permittivity εr of the specimen was calculated according to the following Equation (ii) and defined as relative permittivity of the adhesive layer. The thickness of the specimen was measured using a micrometer.

C_{A}=ε0×εr×π×(L/2)²/d (ii),

ε0: Relative permittivity of vacuum=8.854×10⁻¹²,
L: Diameter of measurement electrode=38 mm,
d: Thickness of adhesive layer

At 100 kHz and 25° C., the adhesive layer has a relative permittivity of about 4.0 or less, and, in an embodiment, about 2.0 to about 4.0.

### Adhesive Strength

A new sample for evaluation was prepared in the same manner as in preparation of the sample for evaluation in durability testing and was cut into a size of 25 mm×100 mm, followed by autoclaving at 50° C. under a pressure of 0.5 MPa for 15 minutes. Then, the sample was left at 23° C. and 55% RH for 1 hour, followed by measurement of adhesive strength.

Adhesive strength of the sample was measured at a peeling angle of 180° and at a peeling rate of 300 mm/min at 23° C. and 55% RH using a tensile tester (Tensilon universal tester STA-1150, Orientech Co., Ltd.) in accordance with the adhesive tape and adhesive sheet testing method of JIS Z0237 (2009). In an embodiment, the adhesive strength is about 30.0 N/25 mm or higher, and, in an embodiment, about 30.0 N/25 mm to about 100.0 N/25 mm.

Evaluation results are shown in Tables 3-1 to 3-2.

TABLE 3-1

| | | | | | | Haze | | | | | | |
|---|---|---|---|---|---|---|---|---|---|---|---|---|
| | | | | | | (%) | | | | | | |
| | | | | | | After | | | | | | |
| | | | | | | being | | | | | Adhesive layer | |
| | | | | | | left | | | | | Mw | |
| | | | | | | under | | | | | (×10⁴) | |
| | Step-filling | | Durability | | | moist | Processability | | Relative | Adhesive | After | After |
| | property | | Heat | Humidity | HS | heat | Curve | Hole | Permittivity | strength | initial | complete |
| | 25° C. | 60° C. | test | test | test | condition | processing | processing | 25° C. | N/25 mm | curing | curing |
| Example | ◯ | ⊚ | ◯ | Δ | ⊚ | 0.25 | ⊚ | Δ | 3.5 | 42.5 | 75 | 60 |
| 1 | | | | | | | | | | | | |
| Example | Δ | ◯ | ◯ | ◯ | ⊚ | 0.22 | ◯ | Δ | 3.2 | 45.1 | 65 | 50 |
| 2 | | | | | | | | | | | | |
| Example | ⊚ | ⊚ | ⊚ | Δ | ⊚ | 0.24 | ⊚ | ◯ | 3.7 | 42.2 | 75 | 60 |
| 3 | | | | | | | | | | | | |
| Example | ⊚ | ⊚ | ⊚ | ⊚ | ⊚ | 0.25 | ⊚ | ⊚ | 2.9 | 54.3 | 75 | 60 |
| 4 | | | | | | | | | | | | |
| Example | ⊚ | ⊚ | ⊚ | ⊚ | ⊚ | 0.24 | ⊚ | ⊚ | 2.9 | 49.7 | 60 | 40 |
| 5 | | | | | | | | | | | | |
| Example | ◯ | ⊚ | ⊚ | ⊚ | ⊚ | 0.23 | ⊚ | ◯ | 2.9 | 58.3 | 94 | 75 |
| 6 | | | | | | | | | | | | |
| Example | ⊚ | ⊚ | ◯ | ⊚ | ◯ | 0.39 | ◯ | ◯ | 2.9 | 42.8 | 42 | 33 |
| 7 | | | | | | | | | | | | |
| Example | ⊚ | ⊚ | ◯ | ◯ | ◯ | 0.39 | ◯ | Δ | 2.9 | 38.5 | 35 | 25 |
| 8 | | | | | | | | | | | | |
| Example | ⊚ | ⊚ | Δ | ◯ | Δ | 0.39 | Δ | Δ | 2.9 | 38.5 | 21 | 19 |
| 9 | | | | | | | | | | | | |
| Example | ⊚ | ⊚ | ⊚ | ⊚ | ⊚ | 0.25 | ⊚ | ⊚ | 2.9 | 46.4 | 75 | 62 |
| 10 | | | | | | | | | | | | |
| Example | ⊚ | ⊚ | ⊚ | ⊚ | ⊚ | 0.26 | ⊚ | ⊚ | 2.9 | 45.3 | 75 | 63 |
| 11 | | | | | | | | | | | | |
| Example | ⊚ | ⊚ | ⊚ | ⊚ | ⊚ | 0.25 | ⊚ | ⊚ | 2.9 | 44.7 | 75 | 60 |
| 12 | | | | | | | | | | | | |
| Example | ⊚ | ⊚ | ⊚ | ⊚ | ⊚ | 0.24 | ⊚ | ⊚ | 2.9 | 42.3 | 65 | 60 |
| 13 | | | | | | | | | | | | |
| Example | ⊚ | ⊚ | ⊚ | ⊚ | ⊚ | 0.22 | ⊚ | ⊚ | 2.9 | 41.9 | 60 | 55 |
| 14 | | | | | | | | | | | | |
| Example | ⊚ | ⊚ | ⊚ | ⊚ | ⊚ | 0.23 | ⊚ | ⊚ | 2.9 | 58.9 | 75 | 60 |
| 15 | | | | | | | | | | | | |
| Example | ⊚ | ⊚ | ⊚ | ⊚ | ⊚ | 0.31 | ⊚ | ⊚ | 2.9 | 45.1 | 100 | 55 |
| 16 | | | | | | | | | | | | |
| Example | ⊚ | ⊚ | ⊚ | ⊚ | ⊚ | 0.30 | ⊚ | ⊚ | 2.9 | 41.3 | 95 | 50 |
| 17 | | | | | | | | | | | | |
| Example | ⊚ | ⊚ | ⊚ | ⊚ | ⊚ | 0.26 | ⊚ | ⊚ | 2.9 | 46.7 | 90 | 50 |
| 18 | | | | | | | | | | | | |
| Example | ◯ | ⊚ | ⊚ | ⊚ | ⊚ | 0.25 | ⊚ | ⊚ | 2.9 | 55.3 | 75 | 60 |
| 19 | | | | | | | | | | | | |
| Example | ⊚ | ⊚ | ⊚ | ⊚ | ⊚ | 0.41 | ⊚ | ⊚ | 2.5 | 42.8 | 56 | 48 |
| 20 | | | | | | | | | | | | |
| Example | ⊚ | ⊚ | ⊚ | ⊚ | ⊚ | 0.46 | ⊚ | ⊚ | 2.3 | 40.5 | 52 | 46 |
| 21 | | | | | | | | | | | | |
| Example | ⊚ | ⊚ | ◯ | ⊚ | ◯ | 0.32 | ◯ | ◯ | 3.1 | 32.6 | 72 | 64 |
| 22 | | | | | | | | | | | | |
| Example | Δ | ◯ | ◯ | ◯ | Δ | 0.35 | Δ | Δ | 2.5 | 42.7 | 73 | 61 |
| 23 | | | | | | | | | | | | |
| Example | ⊚ | ⊚ | ⊚ | ⊚ | ⊚ | 0.29 | ⊚ | ⊚ | 3.5 | 43.5 | 75 | 62 |
| 24 | | | | | | | | | | | | |
| Example | Δ | ◯ | ◯ | Δ | ◯ | 0.26 | ◯ | ◯ | 3.5 | 36.3 | 82 | 67 |
| 25 | | | | | | | | | | | | |
| Example | ⊚ | ⊚ | ⊚ | ⊚ | ⊚ | 0.49 | ⊚ | ⊚ | 2.9 | 48.9 | 79 | 70 |
| 26 | | | | | | | | | | | | |
| Example | ⊚ | ⊚ | ⊚ | ⊚ | ⊚ | 0.24 | ⊚ | ⊚ | 2.9 | 53.2 | 63 | 54 |
| 27 | | | | | | | | | | | | |
| Example | ⊚ | ⊚ | ⊚ | ⊚ | ⊚ | 0.23 | ⊚ | ⊚ | 2.9 | 58.8 | 95 | 75 |
| 28 | | | | | | | | | | | | |

TABLE 3-2

| | | | | | | Haze | | | | | | |
|---|---|---|---|---|---|---|---|---|---|---|---|---|
| | | | | | | (%) | | | | | | |
| | | | | | | After | | | | | | |
| | | | | | | being | | | | | Adhesive layer | |
| | | | | | | left | | | | | Mw | |
| | | | | | | under | | | | | (×10⁴) | |
| | Step-filling | | Durability | | | moist | Processability | | Relative | Adhesive | After | After |
| | property | | Heat | Humidity | HS | heat | Curve | Hole | Permittivity | strength | initial | complete |
| | 25° C. | 60° C. | test | test | test | condition | processing | processing | 25° C. | N/25 mm | curing | curing |
| Comparative | ⊚ | ⊚ | X | Δ | X | 0.85 | X | X | 5.3 | 25.1 | 82 | 71 |
| Example 1 | | | | | | | | | | | | |
| Comparative | ⊚ | ⊚ | ◯ | ◯ | ◯ | 3.53 | Δ | X | 4.5 | 34.3 | 78 | 64 |
| Example 2 | | | | | | | | | | | | |
| Comparative | ⊚ | ⊚ | ◯ | ◯ | ◯ | 0.75 | Δ | X | 4.8 | 35.4 | 77 | 61 |
| Example 3 | | | | | | | | | | | | |
| Comparative | ⊚ | ⊚ | X | ◯ | X | 0.54 | Δ | X | 4.6 | 22.6 | 81 | 56 |
| Example 4 | | | | | | | | | | | | |
| Comparative | ⊚ | ⊚ | ◯ | ◯ | ◯ | 0.43 | ◯ | X | 4.4 | 21.3 | 75 | 62 |
| Example 5 | | | | | | | | | | | | |
| Comparative | ⊚ | ⊚ | X | Δ | X | 10.47 | X | X | 5.2 | 15.1 | 95 | 78 |
| Example 6 | | | | | | | | | | | | |
| Comparative | X | X | ⊚ | ⊚ | ⊚ | 0.25 | ◯ | X | 2.9 | 52.3 | 125 | 51 |
| Example 7 | | | | | | | | | | | | |
| Comparative | X | Δ | ⊚ | ⊚ | ⊚ | 0.26 | ◯ | X | 2.9 | 51.2 | 112 | 56 |
| Example 8 | | | | | | | | | | | | |
| Comparative | ⊚ | ⊚ | X | X | X | 0.25 | X | X | 2.9 | 13.2 | 15 | 12 |
| Example 9 | | | | | | | | | | | | |

From Table 3-1, it can be seen that the adhesive composition according to the present invention had good step-filling properties and durability under harsh conditions (high temperature, high humidity, thermal shock), and exhibited good properties in terms of haze, processability, and adhesive strength after moist heat durability testing while allowing reduction in permittivity.

### Manufacture of Thin Polarizing Plate

A thin polarizing plate was manufactured in the same manner as in Example 1.

### Preparative Example 20

In a reaction box configured to block external UV light, four UV lamps (Black light FL20SBL, Sankyo-Denki Co., Ltd.) were disposed in each of four directions. A 2 L four-necked flask equipped with a stirring blade, a thermometer, a nitrogen gas inlet tube and a cooler was placed in the reaction box. 40 parts of 2-ethylhexyl acrylate, 15 parts of butyl acrylate, 20 parts of 4-hydroxybutyl acrylate and 25 parts of acryloylmorpholine were introduced into the flask and heated to 30° C. while purging with nitrogen gas.

Then, 0.005 parts of 2,2-dimethoxy-1,2-diphenylethane-1-one (Omnirad® 651, IGM Resins B.V.) were introduced as a photopolymerization initiator into the flask while stirring, followed by uniformly mixing the components.

For initiation of polymerization, the mixture was irradiated with UV light using the black light (cumulative light quantity: 200 mJ/cm²). After initiation of reaction, the reaction was stopped by introducing air into the flask using an air pump when the reaction temperature was increased by 10° C., thereby preparing a syrup A-1. In 100 g of the syrup A-1, a partial polymer A2-1 was present in an amount of 10.5 g, and an unreacted monomer was present in an amount of 89.5 g. The glass transition temperature (Tg) and the weight average molecular weight (Mw) of the partial polymer A2-1 contained in the syrup A-1 are shown in Table 4.

### Preparative Examples 21 to 23

Syrups A-2 to A-4 were prepared in the same manner as in Preparative Example 20 except that the kinds and contents of monomers and the content of the photopolymerization initiator were changed as listed in Table 4. In 100 of each of the syrups A-2 to A-4, each of partial polymers A2-2 to A2-4 was present in an amount of 10.5 g and an unreacted monomer was present in an amount of 89.5 g. The glass transition temperature (Tg) and the weight average molecular weight (Mw) of each of the partial polymers A2-2 to A2-4 contained in the syrups A-2 to A-4 are shown in Table 4.

TABLE 4

| | Monomer (parts) | | | | | | Tg | Mw |
|---|---|---|---|---|---|---|---|---|
| | 2EHA | IBXA | BA | 4HBA | ACMO | BzA | (° C.) | (*10⁴) |
| Preparative | 40 | | 15 | 20 | 25 | | −25.3 | 175 |
| Example | | | | | | | | |
| 20 | | | | | | | | |
| (A-1) | | | | | | | | |
| Preparative | 25 | 30 | | 30 | 15 | | 2.2 | 175 |
| Example | | | | | | | | |
| 21 | | | | | | | | |
| (A-2) | | | | | | | | |
| Preparative | 30 | 20 | | 20 | 10 | 20 | −8.6 | 175 |
| Example | | | | | | | | |
| 22 | | | | | | | | |
| (A-3) | | | | | | | | |
| Preparative | 70 | | | 30 | | | −58.4 | 175 |
| Example | | | | | | | | |
| 23 | | | | | | | | |
| (A-4) | | | | | | | | |

### Preparation of Adhesive Composition, Adhesive Layer, and Adhesive Layer-Attached Polarizing Plate

### Example 29

Relative to 100 parts by weight of the syrup A-1 prepared in Preparative Example 20, 0.05 parts of a crosslinking agent (dipentaerythritol hexaacrylate, A-DPH, Shin Nakamura Chemical Industry Co., Ltd.), 0.05 parts of a UV absorbent (hydroxyphenyltriazine UV absorbent, Tinuvin® 479, BASF Japan Ltd.), 0.1 parts of a chain transfer agent (2-ethylhexyl-3-mercaptopropionate, EHMP, SC Organic Chemistry Co., Ltd.), and 0.1 parts of a photopolymerization initiator (1-hydroxycyclohexyl-phenyl ketone, Omnirad® 184, IGM Resins B.V.) were added to the syrup, followed by mixing and degassing, thereby preparing an adhesive composition.

The adhesive composition was deposited to a thickness of 150 μm on one surface of a 75 μm thick polyethylene terephthalate (PET) film subjected to release (silicone) treatment. A 75 μm thick polyethylene terephthalate (PET) film having one surface subjected to release (silicone) treatment was bonded to the adhesive composition deposited on the surface of the PET film to have a sandwich structure in which the adhesive composition was interposed between the surfaces of the PET films subjected to release treatment. The adhesive composition was irradiated with UV light at an irradiance of 2.0 mW/cm² at upper and lower sides thereof (cumulative light quantity: 400 mJ/cm² at each of upper and lower sides of the sandwich structure) to form an adhesive layer.

Next, the PET film was removed from one side of the sandwich structure to expose the adhesive layer, which in turn was attached to the thin polarizing plate, thereby providing an adhesive layer-attached polarizing plate.

### Examples 30 to 47 and Comparative Examples 10 to 19

Adhesive compositions, adhesive layers, and adhesive layer-attached polarizing plates were prepared in the same manner as in Example 29 except that the kinds of syrups, the kinds of additives, and the contents thereof were changed as listed in Table 5-1 and Table 5-2.

TABLE 5-1

| | | | Crosslinking | | | | Chain transfer | | Photopolymerization | |
|---|---|---|---|---|---|---|---|---|---|---|
| | Syrup(A) | | agent | | UV absorbent(B) | | agent(C) | | initiator | |
| | | Content | | Content | | Content | | Content | | Content |
| | Kind | (parts) | Kind | (parts) | Kind | (parts) | Kind | (parts) | Kind | (parts) |
| Example | A-1 | 100 | A-DPH | 0.05 | Tin479 | 0.05 | EHMP | 0.1 | Omnirad184 | 0.1 |
| 29 | | | | | | | | | | |
| Example | A-2 | 100 | A-DPH | 0.05 | Tin479 | 0.05 | EHMP | 0.1 | Omnirad184 | 0.1 |
| 30 | | | | | | | | | | |
| Example | A-3 | 100 | A-DPH | 0.05 | Tin479 | 0.05 | EHMP | 0.1 | Omnirad184 | 0.1 |
| 31 | | | | | | | | | | |
| Example | A-3 | 100 | A-DPH | 0.05 | Tin479 | 0.05 | EHMP | 0.01 | Omnirad184 | 0.1 |
| 32 | | | | | | | | | | |
| Example | A-3 | 100 | A-DPH | 0.05 | Tin479 | 0.05 | EHMP | 5 | Omnirad184 | 0.1 |
| 33 | | | | | | | | | | |
| Example | A-4 | 100 | A-DPH | 0.05 | Tin479 | 0.05 | EHMP | 0.1 | Omnirad184 | 0.1 |
| 34 | | | | | | | | | | |
| Example | A-3 | 100 | A-DPH | 0.05 | Tin479 | 0.1 | EHMP | 0.1 | Omnirad184 | 0.1 |
| 35 | | | | | | | | | | |
| Example | A-3 | 100 | A-DPH | 0.05 | Tin479 | 0.1 | EHMP | 0.05 | Omnirad184 | 0.1 |
| 36 | | | | | | | | | | |
| Example | A-3 | 100 | A-DPH | 0.05 | Tin479 | 0.5 | EHMP | 0.1 | Omnirad184 | 0.1 |
| 37 | | | | | | | | | | |
| Example | A-3 | 100 | A-DPH | 0.05 | Tin479 | 0.01 | EHMP | 0.1 | Omnirad184 | 0.1 |
| 38 | | | | | | | | | | |
| Example | A-3 | 100 | A-DPH | 0.05 | Tin479 | 1 | EHMP | 0.1 | Omnirad184 | 0.1 |
| 39 | | | | | | | | | | |
| Example | A-3 | 100 | A-DPH | 0.05 | Tin479 | 3 | EHMP | 0.1 | Omnirad184 | 0.1 |
| 40 | | | | | | | | | | |
| Example | A-3 | 100 | A-DPH | 0.05 | Tin479 | 5 | EHMP | 0.1 | Omnirad184 | 0.1 |
| 41 | | | | | | | | | | |
| Example | A-3 | 100 | A-DPH | 0.05 | Tin384-2 | 0.05 | EHMP | 0.1 | Omnirad184 | 0.1 |
| 42 | | | | | | | | | | |
| Example | A-3 | 100 | A-DPH | 0.05 | Tin384-2 | 0.1 | EHMP | 0.1 | Omnirad184 | 0.1 |
| 43 | | | | | | | | | | |
| Example | A-3 | 100 | A-DPH | 0.05 | Tin479 | 0.05 | EHMP | 0.1 | TPO | 0.1 |
| 44 | | | | | | | | | | |
| Example | A-3 | 100 | DAP | 0.05 | Tin479 | 0.05 | EHMP | 0.1 | Omnirad184 | 0.1 |
| 45 | | | | | | | | | | |
| Example | A-3 | 100 | EDMA | 0.05 | Tin479 | 0.05 | EHMP | 0.1 | Omnirad184 | 0.1 |
| 46 | | | | | | | | | | |
| Example | A-3 | 100 | DCP-A | 0.05 | Tin479 | 0.05 | NOMP | 0.1 | Omnirad184 | 0.1 |
| 47 | | | | | | | | | | |

TABLE 5-2

| | | | | | | | Chain transfer | | Photopolymerization | |
|---|---|---|---|---|---|---|---|---|---|---|
| | Syrup | | Crosslinking agent | | UV absorbent | | agent | | initiator | |
| | | Content | | Content | | Content | | Content | | Content |
| | Kind | (parts) | Kind | (parts) | Kind | (parts) | Kind | (parts) | Kind | (parts) |
| Comparative | A-3 | 100 | A-DPH | 0.05 | Tin479 | 0 | EHMP | 0 | Omnirad184 | 0.1 |
| Example 10 | | | | | | | | | | |
| Comparative | A-3 | 100 | A-DPH | 0.05 | Tin479 | 0.05 | EHMP | 0 | Omnirad184 | 0.1 |
| Example 11 | | | | | | | | | | |
| Comparative | A-3 | 100 | A-DPH | 0.05 | Tin479 | 0 | EHMP | 0.1 | Omnirad184 | 0.1 |
| Example 12 | | | | | | | | | | |
| Comparative | A-3 | 100 | A-DPH | 0.05 | Tin479 | 0.005 | EHMP | 0.1 | Omnirad184 | 0.1 |
| Example 13 | | | | | | | | | | |
| Comparative | A-3 | 100 | A-DPH | 0.05 | Tin479 | 0.05 | EHMP | 0.005 | Omnirad184 | 0.1 |
| Example 14 | | | | | | | | | | |
| Comparative | A-3 | 100 | A-DPH | 0.05 | Tin479 | 0.1 | EHMP | 6 | Omnirad184 | 0.1 |
| Example 15 | | | | | | | | | | |
| Comparative | A-3 | 100 | A-DPH | 0.05 | Tin384-2 | 0.005 | EHMP | 0.1 | Omnirad184 | 0.1 |
| Example 16 | | | | | | | | | | |
| Comparative | A-3 | 100 | A-DPH | 0.05 | Tin479 | 6 | EHMP | 6 | Omnirad184 | 0.1 |
| Example 17 | | | | | | | | | | |
| Comparative | A-3 | 100 | A-DPH | 0.05 | Tin384-2 | 6 | EHMP | 0.1 | Omnirad184 | 0.1 |
| Example 18 | | | | | | | | | | |
| Comparative | A-3 | 100 | A-DPH | 0.05 | Tin479 | 6 | EHMP | 0.1 | Omnirad184 | 0.1 |
| Example 19 | | | | | | | | | | |

### Evaluation of Adhesive Layer

### Step-Filling Properties

Step-filling properties were evaluated as in evaluation of the step-filling properties in Tables 3-1 to 3-2.

### Property

Polymerization Rate

Each of the adhesive compositions prepared in the Examples and Comparative Examples was deposited to a thickness of 150 μm on one surface of a 75 μm thick PET film subjected to release (silicone) treatment. A 75 μm thick PET film having one surface subjected to release (silicone) treatment was bonded to the adhesive composition deposited on the surface of the PET film to have a sandwich structure in which the adhesive composition was interposed between the surfaces of the PET films subjected to release treatment. The adhesive composition was irradiated with UV light at an irradiance of 2.0 mW/cm² at upper and lower sides thereof so as to provide a cumulative quantity of 350 mJ/cm² and a cumulative quantity of 450 mJ/cm² at upper and lower sides of the sandwich structure, thereby forming an adhesive layer having different cumulative quantities of light. About 1 g of the adhesive layer was extracted, followed by measuring the weight upon extraction (weight before heating) and the weight after evaporating the residual monomer by heating at 180° C. for 30 minutes (weight after heating). A value calculated by the Equation: (weight after heating÷weight before heating)×100 was defined as the polymerization rate (%). A difference in polymerization rate of the adhesive layer having a cumulative quantity of 350 mJ/cm² and a cumulative quantity of 450 mJ/cm² at upper and lower sides thereof, respectively, was calculated and evaluated according to the following criteria.

10: Difference of less than 0.1%

9: Difference of 0.1% to less than 0.2%

8: Difference of 0.2% to less than 0.3%

7: Difference of 0.3% to less than 0.4%

6: Difference of 0.4% to less than 0.5%

5: Difference of 0.5% to less than 0.6%

4: Difference of 0.6% to less than 0.7%

3: Difference of 0.7% to less than 0.8%

2: Difference of 0.8% to less than 1.0%

1: Difference of 1.0% or more

Creep Test

The adhesive layer formed in (1) polymerization rate was cut into a size of 1.5 cm×10 cm. One piece of a polyimide film 11 (Kapton Film, Doray DuPont) subjected to corona treatment and having a size of 50 μm×10 cm×5 cm (thickness×width×length) was attached to one side of an adhesive layer 12, and another piece of the polyimide film 11 was attached to the other side of the adhesive layer 12 in opposite directions, thereby preparing a stacked structure having a size of 10 cm and 8.5 cm. The stacked structure was cut into a sample having a width of 1.5 cm, thereby preparing a creep test sample 10, as shown in FIG. 2. With a film-securing gap set to 4 cm, a texture analyzer TX-AT (EKO Instruments was used and a load of 500 g was applied to the sample for 10 minutes in a tensile direction. A dislocation length (μm) of the adhesive layer was measured, and a value calculated by the Equation: {dislocation length (μm)/thickness (μm) of adhesive layer×100} was defined as a creep value. A difference in creep value of the adhesive layer having a cumulative quantity of 350 mJ/cm² and a cumulative quantity of 450 mJ/cm² at the upper and lower sides thereof, respectively, was calculated and evaluated according to the following criteria.

10: Difference of less than 10%

9: Difference of 10% to less than 20%

8: Difference of 20% to less than 30%

7: Difference of 30% to less than 40%

6: Difference of 40% to less than 50%

5: Difference of 50% to less than 60%

4: Difference of 60% to less than 70%

3: Difference of 70% to less than 80%

2: Difference of 80% to less than 100%

1: Difference of 100% or more

Results are shown in Tables 6-1 to 6-2.

TABLE 6-1

| | | | | | Mw of | |
|---|---|---|---|---|---|---|
| | | | | | adhesive layer | |
| | | | Property stability | | (*10⁴) | |
| | Step-filling | | Poly- | | After | After |
| | property | | merization | | initial | complete |
| | 25° C. | 60° C. | rate | Creep | curing | curing |
| Example 29 | ⊚ | ⊚ | 9 | 9 | 75 | 65 |
| Example 30 | ◯ | ◯ | 10 | 9 | 75 | 65 |
| Example 31 | ⊚ | ⊚ | 10 | 10 | 75 | 65 |
| Example 32 | Δ | ◯ | 10 | 10 | 75 | 65 |
| Example 33 | ⊚ | ⊚ | 5 | 6 | 75 | 65 |
| Example 34 | ⊚ | ⊚ | 9 | 9 | 75 | 65 |
| Example 35 | ⊚ | ⊚ | 9 | 9 | 65 | 55 |
| Example 36 | ◯ | ⊚ | 9 | 8 | 70 | 60 |
| Example 37 | ⊚ | ⊚ | 7 | 6 | 70 | 55 |
| Example 38 | ◯ | ⊚ | 7 | 6 | 70 | 55 |
| Example 39 | ⊚ | ⊚ | 5 | 5 | 55 | 45 |
| Example 40 | ⊚ | ⊚ | 5 | 4 | 50 | 40 |
| Example 41 | ⊚ | ⊚ | 4 | 4 | 70 | 55 |
| Example 42 | ⊚ | ⊚ | 7 | 7 | 72 | 62 |
| Example 43 | ⊚ | ⊚ | 9 | 9 | 65 | 55 |
| Example 44 | ⊚ | ⊚ | 7 | 7 | 72 | 62 |
| Example 45 | ⊚ | ⊚ | 9 | 7 | 71 | 61 |
| Example 46 | ⊚ | ⊚ | 9 | 8 | 67 | 57 |
| Example 47 | ⊚ | ⊚ | 9 | 9 | 70 | 60 |

TABLE 6-2

| | | | | | Mw of adhesive | |
|---|---|---|---|---|---|---|
| | | | Property stability | | layer (*10⁴) | |
| | Step-filling | | Poly- | | After | After |
| | property | | merization | | initial | complete |
| | 25° C. | 60° C. | rate | Creep | curing | curing |
| Comparative | X | X | 2 | 2 | 120 | 100 |
| Example 10 | | | | | | |
| Comparative | X | Δ | 4 | 4 | 120 | 90 |
| Example 11 | | | | | | |
| Comparative | ◯ | ⊚ | 3 | 2 | 75 | 60 |
| Example 12 | | | | | | |
| Comparative | ◯ | ⊚ | 3 | 3 | 15 | 12 |
| Example 13 | | | | | | |
| Comparative | X | Δ | 4 | 4 | 20 | 15 |
| Example 14 | | | | | | |
| Comparative | ⊚ | ⊚ | 1 | 1 | 8 | 6 |
| Example 15 | | | | | | |
| Comparative | ◯ | ⊚ | 3 | 3 | 15 | 12 |
| Example 16 | | | | | | |
| Comparative | — | — | — | — | 6 | 5 |
| Example 17 | | | | | | |
| Comparative | — | — | — | — | 15 | 12 |
| Example 18 | | | | | | |
| Comparative | — | — | — | — | 15 | 12 |
| Example 19 | | | | | | |

In Table 6-2, “-” indicates that curing reaction did not proceed and an unevaluable adhesive layer was obtained.

From the results shown in Tables 6-1 and 6-2, it can be seen that the adhesive compositions according to the present invention stably formed adhesive layers having sufficient step-filling properties.

In Examples 29 to 32, the syrups A were prepared using different monomers. From the results, it can be seen that, even with the different monomers, the adhesive compositions according to the present invention stably formed adhesive layers having sufficient step-filling properties.

While some embodiments have been described herein, it should be understood that various modifications, changes, alterations, and equivalent embodiments can be made by those skilled in the art without departing from the spirit and scope of the present invention.

What is claimed is:

1. A photocurable adhesive composition for optical films, the photocurable adhesive composition comprising a main component and a chain transfer agent,
wherein the main component comprises (a): a (meth)acrylic acid ester copolymer comprising:
about 15 wt % to about 55 wt % of a constituent unit derived from a component (a1): a (meth)acrylic acid ester monomer having a linear or branched C₁ to C₁₄ alkyl group;
about 10 wt % to about 55 wt % of a constituent unit derived from a component (a2): a (meth)acrylic acid ester monomer having a cyclic C₃ to C₁₄ alkyl group;
about 5 wt % to about 35 wt % of a constituent unit derived from a component (a3): a hydroxyl group-containing (meth)acrylic acid ester monomer; and
about 5 wt % to about 35 wt % of a constituent unit derived from a component (a4): an amide group-containing monomer,
wherein a sum of the constituent units derived from the components (a1) to (a4) is 100 wt %, and the constituent unit derived from the component (a1) is present in an amount of about 20 wt % to about 60 wt % based on a total amount of the constituent units derived from the components (a1) and (a2), and
wherein the chain transfer agent is present in an amount of about 0.01 parts by weight to about 5 parts by weight, relative to 100 parts by weight of the main component.

2. The photocurable adhesive composition for optical films according to claim 1, further comprising: a constituent unit derived from a component (a5): a radical polymerizable functional group-containing (meth)acrylic acid ester monomer other than the components (a1), (a2), (a3), and (a4).

3. The photocurable adhesive composition for optical films according to claim 2, wherein the component (a5) comprises an aromatic hydrocarbon group-containing (meth)acrylic acid ester monomer.

4. The photocurable adhesive composition for optical films according to claim 2, wherein the component (a5) comprises a branched C₁₈ to C₃₆ alkyl group-containing (meth)acrylic acid ester monomer.

5. The photocurable adhesive composition for optical films according to claim 2, wherein the constituent unit derived from the component (a5) is present in an amount of about 8 parts by weight to about 45 parts by weight, relative to 100 parts by weight of a total of the constituent units derived from the components (a1) to (a4).

6. The photocurable adhesive composition for optical films according to claim 1, wherein the component (a2) comprises at least one of isobornyl (meth)acrylate and cyclohexyl (meth)acrylate.

7. The photocurable adhesive composition for optical films according to claim 1, wherein the (meth)acrylic acid ester copolymer (a) has a glass transition temperature of about −40° C. to less than about 20° C.

8. The photocurable adhesive composition for optical films according to claim 1, further comprising a crosslinking agent.

9. The photocurable adhesive composition for optical films according to claim 8, wherein the crosslinking agent is present in an amount of about 0.01 parts by weight to about 5 parts by weight, relative to 100 parts by weight of the main component.

10. The photocurable adhesive composition for optical films according to claim 8, wherein the crosslinking agent comprises at least one of an isocyanate compound, a carbodiimide compound, an oxazoline compound, an epoxy compound, a multifunctional (meth)acrylic acid ester monomer, a multifunctional allyl monomer, and a peroxide.

11. The photocurable adhesive composition for optical films according to claim 1, further comprising:
about 0.001 parts by weight to about 5 parts by weight of a silane coupling agent, relative to 100 parts by weight of the main component.

12. The photocurable adhesive composition for optical films according to claim 1, further comprising a high softening point resin.

13. The photocurable adhesive composition for optical films according to claim 12, wherein the high softening point resin is a rosin ester based resin.

14. A photocurable adhesive layer for optical films formed of the photocurable adhesive composition for optical films according to claim 1.

15. The photocurable adhesive layer for optical films according to claim 14, wherein the photocurable adhesive layer has a weight average molecular weight of about 50,000 to about 1,000,000.

16. The photocurable adhesive layer for optical films according to claim 14, wherein the photocurable adhesive layer has a thickness of about 20 μm to about 1 mm.

17. An optical member comprising a cured product of the photocurable adhesive layer according to claim 14, and a first optical member on a first surface of the cured product of the photocurable adhesive layer.

18. The optical member according to claim 17, further comprising:
glass, a poly(methyl methacrylate) plate, a polycarbonate plate, or a second optical film on a second surface of the cured product of the photocurable adhesive layer opposite to the first surface.

19. The optical member according to claim 17, further comprising:
at least one bonding facilitation layer between the first optical film and the cured product of the photocurable adhesive layer.

20. The optical member according to claim 17, wherein the bonding facilitation layer comprises a first bonding facilitation layer and a second bonding facilitation layer, and the optical member has a structure comprising the first optical film, the first bonding facilitation layer, the second bonding facilitation layer, and the cured product of the photocurable adhesive layer sequentially stacked.

21. A display apparatus comprising at least one optical member according to claim 17.

22. A method of forming a photocurable adhesive layer for optical films, the method comprising:
coating the photocurable adhesive composition for optical films according to claim 1 onto a surface of a first release sheet subjected to release treatment to form a coating layer;
stacking a second release sheet on the coating layer such that a surface of the second release sheet subjected to release treatment adjoins a surface of the coating layer; and
irradiating the coating layer with actinic energy through at least one of the first release sheet and the second release sheet.

23. The method according to claim 22, wherein a cumulative quantity of the actinic energy is in a range of about 300 mJ/cm² to about 2,000 mJ/cm².

24. A photocurable adhesive composition for optical films, the photocurable adhesive composition comprising: a syrup obtained through partial polymerization of a (meth)acrylic acid ester monomer composition; a UV absorbent; and a chain transfer agent, wherein the UV absorbent is present in an amount of about 0.010 parts by weight to about 5 parts by weight, and the chain transfer agent is present in an amount of about 0.010 parts by weight to about 5 parts by weight, relative to 100 parts by weight of the syrup.

25. The photocurable adhesive composition for optical films according to claim 24, wherein a partial polymer contained in the syrup has a glass transition temperature of about −60° C. to less than about 20° C.

26. The photocurable adhesive composition for optical films according to claim 24, wherein the (meth)acrylic acid ester monomer composition comprises a cyclic C₃ to C₁₄ alkyl group-containing (meth)acrylic acid ester monomer.

27. The photocurable adhesive composition for optical films according to claim 24, wherein the (meth)acrylic acid ester monomer composition comprises an aromatic hydrocarbon group-containing (meth)acrylic acid ester monomer.

28. A photocurable adhesive layer for optical films formed of the photocurable adhesive composition for optical films according to claim 24.

29. An optical member comprising a cured product of the photocurable adhesive layer according to claim 28, and a first optical member on a first surface of the cured product of the photocurable adhesive layer.

30. A display apparatus comprising at least one optical member according to claim 29.
